(19) United States
(12) Patent Application Publication
(10) Pub. No.: US 2025/0124410 A1
(43) Pub. Date: Apr. 17, 2025

(54) Systems and Methods for Management of Equestrian Events

(71) Applicant: Pegasus App Inc., De Leon, FL (US)

(72) Inventors: Samuel Vernon Baynes, De Leon, FL (US); Jennifer Elizabeth Tankel, De Leon, FL (US)

(73) Assignee: Pegasus App Inc., De Leon, FL (US)

(21) Appl. No.: 18/914,170

(22) Filed: Oct. 12, 2024

Related U.S. Application Data
(60) Provisional application No. 63/589,929, filed on Oct. 12, 2023.

(51) Int. Cl. G06Q 10/1093; G06F 3/0486; H04L 51/04; H04L 67/55

(52) U.S. Cl. CPC G06Q 10/1093; G06F 3/0486; H04L 51/04; H04L 67/55

(57) ABSTRACT

The present disclosure provides systems and methods for managing event participation and notification. The system may perform operations including: obtaining participant data from user devices, obtaining event configuration data, obtaining event-participant data, generating a published order using an event ordering user interface for a first event, push notifying participants of their place in the published order, generating a global event ordering user interface in response to a change trigger condition, retrieving and populating orders for all events, automatically including conflict indicators, re-ordering participants, republishing the orders, and push notifying affected participants of changes. The system enables efficient management of complex event schedules, automatic conflict detection, and real-time participant notifications.

### CROSS-REFERENCE TO RELATED APPLICATION(S)

This application claims the benefit of priority of U.S. Provisional Application No. 63/589,929, filed Oct. 12, 2023.

The contents of each of the above referenced applications are hereby incorporated by reference in its entirety.

### TECHNICAL FIELD

Various aspects of the present disclosure relate generally to systems and methods for management of equestrian events.

### BACKGROUND

Generally, equestrian events have various stakeholders that need to interact to host, compete, and attend equestrian events. Finding, interacting with, and managing relationships of the various stakeholders currently has efficiency costs, errors, or risks for participants.

Equestrian events are complex, multi-faceted competitions that involve numerous participants, including riders, horses, trainers, sponsors, vendors, owners, and support staff. These events often range from single day events through to many months long competitions and feature various disciplines such, but not limited to, as dressage, show jumping, western, and cross-country riding. The coordination and management of such events present significant logistical challenges for organizers, participants, and spectators alike.

Traditionally, equestrian event management has relied heavily on manual processes, paper-based systems, and basic digital tools. These methods often lead to inefficiencies, communication gaps, and difficulties in adapting to last-minute changes. For instance, updating ride times or notifying participants of schedule changes can be time-consuming and prone to errors when relying on manual methods.

The dynamic nature of equestrian competitions, where multiple events may occur simultaneously across different venues/facilities, further complicates the management process. Organizers must juggle numerous variables, including rider and horse availability, venue capacity, and time constraints. This complexity increases the likelihood of scheduling conflicts and can impact the overall flow and success of the event.

Moreover, the equestrian community has unique communication needs. Effective coordination between riders, trainers, event staff, and officials is crucial for the smooth operation of competitions. However, existing communication methods may not adequately address the specific requirements of equestrian events, such as the need for real-time updates and role-based messaging.

As technology continues to advance, there is a growing expectation for more sophisticated, user-friendly solutions in all aspects of life, including sports event management. Participants, spectators, and organizers increasingly seek streamlined, digital approaches to event coordination, scheduling, and communication.

The equestrian industry, while steeped in tradition, is not immune to these technological trends. There is a clear need for innovative solutions that can address the unique challenges of equestrian event management while leveraging modern technology to enhance the experience for all stakeholders involved.

The present disclosure is directed to overcoming one or more of these above-referenced challenges.

### SUMMARY OF THE DISCLOSURE

According to certain aspects of the disclosure, systems, methods, and computer readable memory are disclosed for management of equestrian events.

In some cases, a system may include: at least one memory configured to store instructions; and at least one processor executing the instructions to perform operations. The operations may include: obtain, via participant user interfaces, participant data from a plurality of user devices, wherein the participant data includes data regarding a plurality of riders, a plurality of horses with each being associated with a first one or more riders, and a plurality of trainers with each being associated with a second one or more riders; obtain, via event configuration interfaces, event configuration data, wherein the event configuration data includes data regarding a plurality of events, a plurality of locations, and a time-location mapping of events to locations at specific blocks of time; obtain, via registration user interfaces, event-participant data, wherein the event-participant data includes data regarding a selection of events, the rider for the events, the horse for the events, and the trainer for the events; in response to a request to view an event ordering user interface for a first event, generate the event ordering user interface, wherein the event ordering user interface is configured to: populate participants registered for the first event; automatically order populated participants in an order; automatically detect conflicts with a remainder of the events; re-order participants in the order; and publish the order for the first event; in response to the order being published, push notify the participants of their place in the order by push notification; in response to a change trigger condition, notify the user; in response to a request to view a global event ordering user interface based on the change trigger condition, generate the global event ordering user interface, wherein the global event ordering user interface is configured to: retrieve orders for all events, wherein the orders, respectively, include ordered lists of participants at specific time slots and a location for a respective event; populate segments of the global event ordering user interface with the orders for all the events; automatically include conflict indicators for the participants that have one or more conflicts; re-order participants in the orders; and republish the orders; in response to the orders being republished, determine affected participants; and push notify the affected participants of their place(s) in the order(s) that have changed by push notification.

In some cases, a computer-implemented method may include: obtaining participant data from a plurality of user devices; obtaining event configuration data; obtaining event-participant data; generating a published order using an event ordering user interface for a first event based on the participant data, the event configuration data, and the event-participant data; push notifying participants of their place in the published order;

In some cases, a non-transitory computer-readable medium may store instructions that, when executed by at least one processor, cause—at least one processor to perform operations. The operations may include: generating a global event ordering user interface; retrieving orders for events; populating the global event ordering user interface with the orders including indicators for timeslot conflicts in the global event ordering user interface; modifying the orders; publishing the modified orders; and notifying participants of changes in the republished orders.

Additional objects and advantages of the disclosed technology will be set forth in part in the description that follows, and in part will be apparent from the description, or may be learned by practice of the disclosed technology.

It is to be understood that both the foregoing general description and the following detailed description are exemplary and explanatory only and are not restrictive of the disclosed technology, as claimed.

### BRIEF DESCRIPTION OF THE DRAWINGS

The accompanying drawings, which are incorporated in and constitute a part of this specification, illustrate various exemplary aspects and together with the description, serve to explain the principles of the disclosed technology.

FIG. 1 illustrates an example environment for management of equestrian events.

FIG. 2 illustrates a system diagram of an event management and notification system, according to an embodiment.

FIG. 3A illustrates a sequence diagram of a system for managing event configurations and participant data, in accordance with example embodiments.

FIG. 3B illustrates a sequence diagram of a system for transmitting targeted push notifications, according to aspects of the present disclosure.

FIG. 3C illustrates a sequence diagram of a process for updating and notifying users about changes in a global event ordering system, according to an embodiment.

FIG. 4A illustrates a first event configuration interface for managing equestrian events, according to aspects of the present disclosure.

FIG. 4B illustrates a second event configuration interface for an equestrian event management system, according to an embodiment.

FIG. 4C illustrates an event ordering user interface for managing equestrian event participants and schedules, according to aspects of the present disclosure.

FIG. 4D illustrates notification interfaces for a mobile device application, according to an embodiment.

FIG. 4E illustrates a published event interface for an equestrian event management system, according to aspects of the present disclosure.

FIG. 4F illustrates a global event ordering interface for managing multiple equestrian events, according to an embodiment.

FIG. 5A illustrates an event-level message user interface for an event management system, according to aspects of the present disclosure.

FIG. 5B illustrates a platform-level message user interface for an equestrian event management system, according to an embodiment.

FIG. 5C illustrates a message interface for creating a new message within an equestrian event management system, according to aspects of the present disclosure.

FIG. 6 illustrates a flowchart for a method of managing event participation and notification, according to aspects of the present disclosure.

FIG. 7 illustrates a flowchart for a method of managing global event ordering, in accordance with example embodiments.

FIG. 8 illustrates an example system that may execute techniques presented herein.

### DETAILED DESCRIPTION

Various aspects of the present disclosure relate generally to management of equestrian events.

In some cases, the systems and methods of the present disclosure may provide user interactions, user interface flows, data flows, and data management thereof for equestrian events. In some cases, a platform for management of equestrian events may be used by stakeholders in order to effectively engage with, manage and participate in equestrian events and competitions. A difference of the platform may be that the platform operates like a social media platform built around a sport (e.g., equestrian events and competitions). In some cases, organizers, brands (e.g., vendors), riders and horses may have a profile page where their previous images, competition history, scores, and the like can be viewed at any point. In some cases, users (e.g., organizers, brands, riders) can also follow, connect, and message one another.

Thus, methods and systems of the present disclosure may be improvements to computer technology and/or equestrian events and competitions.

### 1. Environment

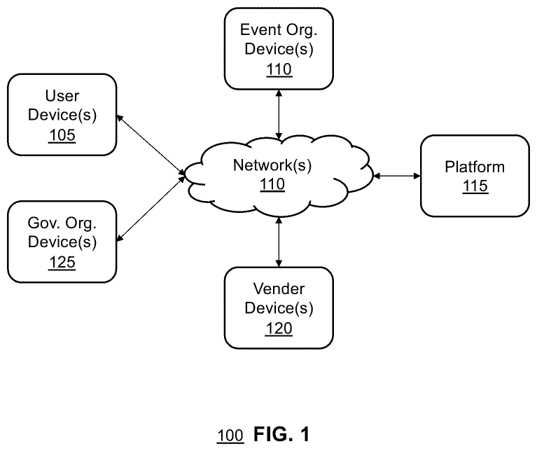

FIG. 1 shows an example environment 100 for management of equestrian events. The environment 100 may include networks 110, user device(s) 105, event organizer device(s) 110, a platform 115, vendor device(s) 120, and governing organization device(s) 125.

The platform 115 may be a computer, a server or set of servers, a cloud system, or a combination of the foregoing. In some cases, the platform 115 may be locally hosted, instead of in the cloud. The platform 115 may coordinate data and/or instructions between various devices of the environment 100, as discussed herein.

The networks 110 may include one or more local networks, private networks, enterprise networks, public networks (such as the internet), cellular networks, and satellite networks, to connect the various devices in the environment 100. Generally, the various devices of the environment 100 may communicate over network(s) 110 using, e.g., network communication standards that connect endpoints corresponding to the various devices of the environment 100.

The event organizer device(s) 110 (hereinafter “event organizer device 110” for ease of reference) may be a personal computing device, such as a cell phone, a tablet, a laptop, wearables (e.g., smart watches), or a desktop computer. In some cases, the event organizer device 110 may be an extended reality (XR) device, such as a virtual reality device, an argument reality device, a mixed reality device, and the like. In some cases, the event organizer device 110 may be associated with an organization and/or user associated with the organization (e.g., an equestrian event organizer and end users thereof, referred to as “organizer” hereinafter). The organizer may have a user account associated with the event organizer device 110 that uniquely identifies the organizer (e.g., within the platform 115). Additional features of the event organizer device 110 and interactions with other devices are described herein.

The user device(s) 105 (hereinafter “user device 105” for ease of reference) may be a personal computing device, such as a cell phone, a tablet, a laptop, wearables (e.g., smart watches), or a desktop computer. In some cases, the user device 105 may be an extended reality (XR) device, such as a virtual reality device, an argument reality device, a mixed reality device, and the like. In some cases, the user device 105 may be associated with a user (e.g., an equestrian athlete). The user may have a user account associated with the user device 105 that uniquely identifies the user (e.g., within the platform 115). Additional features of the user device 105 and interactions with other devices are described herein.

The vendor device(s) 120 (hereinafter “vendor device 120” for ease of reference) may be a personal computing device, such as a cell phone, a tablet, a laptop, or a desktop computer. In some cases, the vendor device 120 may be an extended reality (XR) device, such as a virtual reality device, an argument reality device, a mixed reality device, and the like. In some cases, the vendor device 120 may be associated with a vendor (e.g., a business) and/or user associated with the vendor (e.g., an equestrian equipment supplier and end users thereof, referred to as “vendor” hereinafter). The vendor may have a user account associated with the vendor device 120 that uniquely identifies the vendor (e.g., within the platform 115). Additional features of the vendor device 120 and interactions with other devices are described herein.

The governing organization device(s) 125 (hereinafter “governing organization device 125” for ease of reference) may be a personal computing device, such as a cell phone, a tablet, a laptop, or a desktop computer. In some cases, the governing organization device 125 may be an extended reality (XR) device, such as a virtual reality device, an argument reality device, a mixed reality device, and the like. In some cases, the governing organization device 125 may be associated with a governing body (e.g., a regulator of equestrian events) and/or user associated with the governing body (referred to as “governing body” hereinafter). The governing body may have a user account associated with the governing organization device 125 that uniquely identifies the governing body (e.g., within the platform 115). Additional features of the governing organization device 125 and interactions with other devices are described herein.

In some cases, the event organizers (interacting via event organizer device 110) may be the users that will host, manage, score and monetize equestrian events and competitions.

In some cases, event organizers may create a business account for their equestrian business or organization. The business account may include their logo, regulatory information, address, and the like. The event organizers may also add staff profiles to their team (like a Facebook friend) and add documents (e.g., legal paperwork) that is specific to their property/event.

In some cases, once the event organizers have their account set up, the event organizers may create an event (e.g., like one would create a Facebook event). The event may have details pertaining specifically to equestrian sports and events (e.g., documents that must be signed and horse food that must be purchased).

Once the event is published, the platform may create an event page. Competitors may review the page and register. Once users begin to register, the organizer may have access to an event management dashboard. In this dashboard, the organizer may review various data in different tabs, such as the four tabs discussed herein.

A first tab 1 may be called administrator and provides the organizer with the ability to see who has registered and whether they have completed their paperwork, signed their documents, and had no outstanding black marks against their name with the governing body.

A second tab 2 may be called operations, and the organizer can organize which horse goes in which barn, manage sales of horse food, adjust the schedule, and score the competition.

A third tab 3 may be finances through which event organizers can see who has paid, what they bought, if they requested a refund and then process refunds if needed.

A fourth tab 4 may be a message interface, through which the event organizer can message the competitors, staff, spectators, vendors, sponsors, and the like. Either all together, one person at a time or in groups (e.g., message all sponsors).

Once the event is over, the organizer can make sure that all refunds have been processed and then close and save the event. The money from the event may then be sent to a bank account and the platform may obtain a commission (e.g., 5%).

In some cases, the riders (interacting via user devices 105) may be users who will participate in equestrian events and competitions.

In some cases, the users may set up accounts. For instance, the users may create a user account and add their profile picture, location, regulatory information, and the like (e.g., like a LinkedIn profile but it pertains to equestrian competition experience). The users/riders may connect their account via API to various regulatory bodies in the equestrian industry and view whether their account is considered eligible to compete in various events, or not allowed to compete because their account is ineligible.

The users/riders may also add their horses to their profile. This may require setting up a comprehensive profile per horse, much like you would a rider's profile. Horses profiles may also be checked against governing bodies database to see if they have any profile errors.

The users/riders may add team members to their profile and grant each team member authority to register them for events. The users/riders may also grant their teammates authority to send them paperwork to sign and bills to pay.

In some cases, the users may search and register for events. For instance, once a user/rider profile is live, users/riders may be able to search for events using an interface where you can filter event types, search via a map, and the like. Once the users/riders find an event they are interested in, the users/riders may view the event page and can see what paperwork is required, who else has registered, photos of the event, the profiles of the staff and judged for the event, and the like. From the event page, the users/riders may bookmark the event and return to the event page later, they can register, they can join the wait list if it is full, or they can buy spectator tickets or auditing tickets.

If the users/riders register to compete in an event, the users/riders may go through a registration process. The registration process may require the users/riders to select the events they want to compete in, sign their documents (e.g., legal paperwork) and pay their registration fees.

Once registered, the users/riders may view the event registration information in a My Event dashboard (e.g., specific to that user). The users/riders may view the receipt for the bills they paid, they can see the status of their event paperwork (signed or unsigned) and they can view the status of their team members paperwork (sign or unsigned). If a team member has not signed, they can send them a notification reminder to sign their paperwork, which will be sent as both a push notification and/or an email to the team member.

In some cases, the users/riders may participate in events. Once an event starts, the users/riders may interact with the platform in the following ways:
(1) Scratch. Scratch from events/classes, which means the users/riders can withdraw from events the users/riders have registered to compete in and the users/riders may request a refund for withdrawing.
(2) Add. The users/riders can add to an associated registration. The users/riders may add more events to their registration to participate in, or compete in, if the event is a competition.
(3) View ride times. The users/riders may be able to view their ride times on the platform (e.g., via a mobile application). The users/riders may pull up the schedule for each event in the mobile application and see when they are scheduled to ride, as well as when everyone else is scheduled to ride. If the users/riders ride time changes, the users/riders will receive a push notification notifying them of the fact. If their event is canceled or delayed, they will receive notifications of that as well.
(4) View scores. Once a user/rider has participated in the event, the user/rider may be able to view feedback from the event organizing staff and/or judges. In a competition for example, the users/riders may be able to see their scores as well as the scores of everyone else they were competing against and see where they ranked in the event. The users/riders may be notified automatically of these scores by push notification. The users/riders may also open the scores at any point and view the scores of everyone in the class whose scores have been published.
(5) View vendor/sponsor pages. Through the event page, there will be links/logos of companies that indicate that the brand has either sponsored or vendored the event. By clicking on the links/logo, the users/riders may go to that companies page and review their business services, products, news updates, and about that company.
(6) View nearby businesses. Nearby businesses may be able to pay the organizer to display on a map of business near the show such as coffee shops, restaurants, hotels, etc. During an event (and prior) the users/riders may view the map and see the businesses and their business pages.
(7) View newsfeed. Each event may have a newsfeed (e.g., like a Facebook wall). Updates that contributors to the event make, will populate the feed so people can scroll it to stay ‘in the know’. The users/riders may review this at any time and they can filter the feed by who posted it. For instance, only show me updates from the event organizer.
(8) Buy and use tickets. The users/riders and spectators may purchase tickets to an event, without participating in the event. Once tickets are purchased, the tickets may be saved to respective profiles and the users/riders/spectators may use them, as well assign them to people and send them to the person via email.
(9) View, present and share event paperwork. At any point, users/riders may pull up their event paperwork and view it, download it, email to someone or send it to someone within the app.
(10) Message event organizer. The users/riders may message the event organizer at any time. The users/riders may click on the message button for the event organizer and send them a message. This opens a two way communication channel where the event organizer can message back and forth with the users/riders.
(11) View event staff and their profile. The users/riders may see all the staff that are participating in an event. If the users/riders click on the staff members profile, the users/riders can open their profile and view their personal details, events that have worked at in the past, their judging certifications, and the like.
(12) View profiles of other competitors and team members. The users/riders may see all the other riders that are participating in an event. If the users/riders click on the members profile, the users/riders can open their profile and view public information, events that have participated in, in the past, the events they are registered for in the future, their horses and their horses performance history.
(13) Sign paperwork. If new paperwork needs to be signed during an event, then the users/riders may access it via their paperwork tab in their profile and sign it with the click of a button.
(14) Pay bills, view receipts and share bills. If new bills need to be paid during an event, then the users/riders may access it via their bills tab in their profile and pay it with the click of a button with a payment method (e.g., credit card) saved to their account.
(15) Add, view and export media. The users/riders may shoot footage on their phones and upload it to the platform. While doing so, the users/riders can select who the rider is by their profile details. This may tag the footage to that rider. Once tagged, all riders can look up footage from the event and find all the footage they are tagged in. The users/riders may export the media to share on other platforms like social media platforms. During the export, the platform may overlay event details in a filter, such as the event, score, sponsor, and the like. For instance, this may make the exported media appear like a professional video taken from a live broadcast. The users/riders may share the exported media wherever they want.

In some cases, the vendors (e.g., businesses, interacting via vendor devices 120) may be users who will sponsor and vendor equestrian events and competitions. In some cases, the vendors may set up an account with the platform. For instance, the vendor may sign up and create a business account with the platform.

In creating a business account, the vendors may add various data or options. For instance, the vendors may add four things:
(1) News updates. The vendors may add any updates that the vendors want users on the platform to see when they come to their business page. This can be anything, from a blog the vendor wrote to an announcement of a celebrity rider signing autographs at their vendor tent.
(2) Products. The vendors may add images, title, description and price to anything they want. The vendors may post an item of clothing or they can post an ad to an email subscription service. The vendors may add as many products as they like and program each product to link to a unique URL. When a user clicks on the product ‘More’ button, the user interface may open the unique URL in a new web browser.
(3) Deals. These may be same or different from the product posts. A difference may be that the vendor may list a sales price and discount code, which may display to users so they know there is a discount.
(4) About. The about page on a vendor profile may list the companies name, story, contact details, location and links to the businesses website and social media pages. The about page may serve to help users/riders learn more about the business.

Once a business page and all its components (or a subset thereof) are created, the vendor may click publish and all users on the platform will be able to view the page and all its posts.

In some cases, the vendors may search events to sponsor/vendor. For instance, the vendor may access a dashboard that allows the vendor to search every event on the platform. The vendor may search events by name, and they can filter the events by type event, discipline/sport, location, the amount of people attending, and the cost to sponsor/vendor the event. When the vendor finds an event they want to sponsor/vendor, they click on it and view the full event page.

On the full event page, the vendor may review the events details, as well as who else has sponsored the event. The vendor may use this information to determine if they want to sponsor/vendor the event.

If the vendor determines to sponsor/vendor the event, the vendor will click on a ‘Sponsor/Vendor Event’ button. This will navigate the vendor to a page where they can purchase sponsor/vendor items.

In some cases, the vendors may sponsor/vendor events. On a sponsor/vendor event page, the vendor can view categories of items. For instance, the items may be items to purchase, such as:
(1) Sponsor event. The vendor may view their ability to sponsor the event and that the vendor has been labeled a sponsor (if selected/purchased).
(2) Vendor event. The vendor may have the ability to buy a vendor spot at the event, such as purchasing a vendor tent on the ground of the event.
(3) Virtual vendor. The vendor may have ability to be tagged as a virtual vendor and only display their business page in the platform (via the mobile application/website). In this case, the vendor would not have a physical on-site location at the event.
(4) Nearby businesses. The vendor may enable a vendor the ability to be tagged as a nearby business, and may show the vendor in the platform as a business that is physically located nearby to the event.

The business may review the items to purchase and add the selected items to their shopping cart. When ready, the vendor may will navigate to checkout and using a payment method (e.g., credit card saved on file), the vendor may purchase the items in their cart with the revenue from the purchases being sent to the event organizers account.

Once the purchase is complete, the business account may display on the event page in its relevant spot. For example, if the vendor bought a sponsorship item, it may be visible on the event page tagged as an event sponsor.

When a user reviews an event page and views a vendor listed as a sponsor, the user may click on the link/business logo and be navigated to the business profile. On the business profile, the user can review the businesses posts and click the links to visit the businesses external links. In some cases, the platform may host sales pages for vendors to sell products through the platform.

In some cases, the platform may provide different options to vendors (e.g., based on parameters/settings set by event organizers).

In some cases, the vendors may be able to select different sponsor classes. Events within events are called ‘classes’. A vendor may sponsor individual classes within an event in the same manner the vendor can sponsor the event itself.

In some cases, the vendors may be able to sponsor prize money. Events often give away prize money. The vendor may elect to pay the event organizer to brand the prize money, or provide the prize money themselves. For example, a vendor may pay the event organizer an amount (e.g., $10,000), which the event organizer will then give to the winner of that event. In effect, the brands are sponsoring the prize money.

In some cases, the vendors may be able to select a physical sponsor option. Beyond sponsoring an event and having the businesses profile displayed on the event page, the vendor may sponsor the event physically. For example, a vendor may buy from the event organizer a ‘Physical sign’ item, such as a banner on a fence, and then pay through the platform checkout process like any other item. After payment, the vendor and event organizer may connect via direct message to organize the creation and placement of the physical sign at the event location.

In some cases, the vendors may select a nearby business option. When vendors purchase a ‘Nearby Business’ item through the platform, the vendor may be buying the right to appear on a map in the platform that shows map pins to nearby businesses, that can be filtered by category. When a user at the event opens the map, the user may see all the nearby businesses that paid to show up on the map. For example, a user may filter the map to see all nearby coffee shops, and they will see the business profiles for the coffee shops that paid to be a nearby business.

In some cases, governing bodies (interacting via governing organization devices 125) may use the platform to collect fees and scores, view event paperwork, and communicate with participants and event organizers.

In some cases, the governing bodies may create a governing body account. This may include adding their logo, organization name, contact details and regulator specific details. Once published, this page may be public. Once an account is created, they can view all events that fall under their jurisdiction in a dashboard. The governing bodies may search for and filter these events in order to find a specific event. Once the governing bodies click on an individual event, the governing bodies may look up all operational details from the event, including but not limited to, who registered, how many people were on the waitlist, how much registration revenue was made, and any reporting such as reported falls by riders.

In order to view an individual participant's data, the governing bodies may click on a single participant in a single event. This will show the governing bodies the participants' event participation data, including the events they participated in, the team members they registered with, the scores they earned and the paperwork they signed for the event.

Governing bodies may also view member only data or industry wide data in their dashboard (e.g., data aggregated by the platform). For example, the governing bodies may view the total fees paid to them as the regulator across all events the governing bodies regulated between specific dates. The governing bodies may also pull up all rider fall data, or other data that pertains to the events they regulated.

Outside of a single event, the governing bodies may also maintain a public page. On this page, the governing bodies may post important announcements, rules changes and more (e.g., anything the governing bodies feel is important for their members of their jurisdiction to know).

Governing bodies may also message event organizers and participant accounts, as well as send platform wide push notifications.

### 2. Platform, Notification Management, and Sequence Flows

The present disclosure relates to a system for managing equestrian events. The system may include functionalities for handling participant data, event configurations, and registration processes. The participant data may encompass information regarding stakeholder, such as riders, horses, trainers, owners, coaches, and/or grooms associated with the event. Event configurations may involve details about the events, locations, and a time-location mapping of events to specific time slots. The registration process may involve the selection of events, riders, horses, trainers, owners, coaches, and/or grooms for the events.

In some embodiments, the system may provide an event ordering user interface for managing the order of participants in an event. The interface may be configured to automatically order participants, detect conflicts with other events, re-order participants, and publish the order for the event. Upon publishing the order, the system may push notifications to the participants informing them of their place in the order.

In response to a change trigger condition, the system may notify the user and generate a global event ordering user interface. This interface may retrieve orders for all events, populate segments of the interface with the orders, include conflict indicators for participants with conflicts, re-order participants in the orders, and republish the orders. Upon republishing the orders, the system may determine affected participants and push notifications to these participants informing them of changes in their place in the order.

The system may also include a messaging component that allows for direct and group messaging with groups of people associated with a specific event. This feature may streamline communication and provide a context-specific messaging platform for event organizers, participants, and other stakeholders.

These and other aspects of the system may provide an efficient and user-friendly solution for managing equestrian events, addressing the unique challenges and requirements of such events.

FIG. 1 illustrates an environment 100 for managing equestrian events. The environment 100 includes user devices 105, event organizer devices 110, vendor devices 120, governing organization devices 125, networks 110, and a platform 115. The user devices 105, event organizer devices 110, vendor devices 120, and governing organization devices 125 are connected to the networks 110, which facilitate communication between these devices and the platform 115. The networks 110 may include various types of communication networks such as local area networks, wide area networks, or the internet.

The platform 115 is connected to the networks 110 and serves as a central system for coordinating and managing equestrian events. It processes data and requests from the various connected devices, enabling event organization, participant management, and communication among different stakeholders in equestrian events. In some cases, the platform 115 may include at least one memory configured to store instructions and at least one processor executing the instructions to perform operations. These operations may include obtaining participant data, event configuration data, and event-participant data, generating event ordering user interfaces, publishing event orders, and notifying users of changes in event orders, among others.

The user devices 105 may be personal computing devices, such as cell phones, tablets, laptops, wearables (e.g., smart watches), or desktop computers, used by users who participate in equestrian events and competitions. The event organizer devices 110 may be similar computing devices used by event organizers to host, manage, schedule, score, and monetize equestrian events and competitions. The vendor devices 120 may be similar computing devices used by vendors who sponsor and vendor equestrian events and competitions. The governing organization devices 125 may be similar computing devices used by governing bodies to collect fees and scores, view event paperwork, and communicate with equestrians and event organizers.

In some aspects, the environment 100 provides a comprehensive solution for managing equestrian events, addressing the unique challenges and requirements of such events. The system may provide functionalities for handling participant data, event configurations, and registration processes, among others, thereby facilitating efficient and user-friendly management of equestrian events.

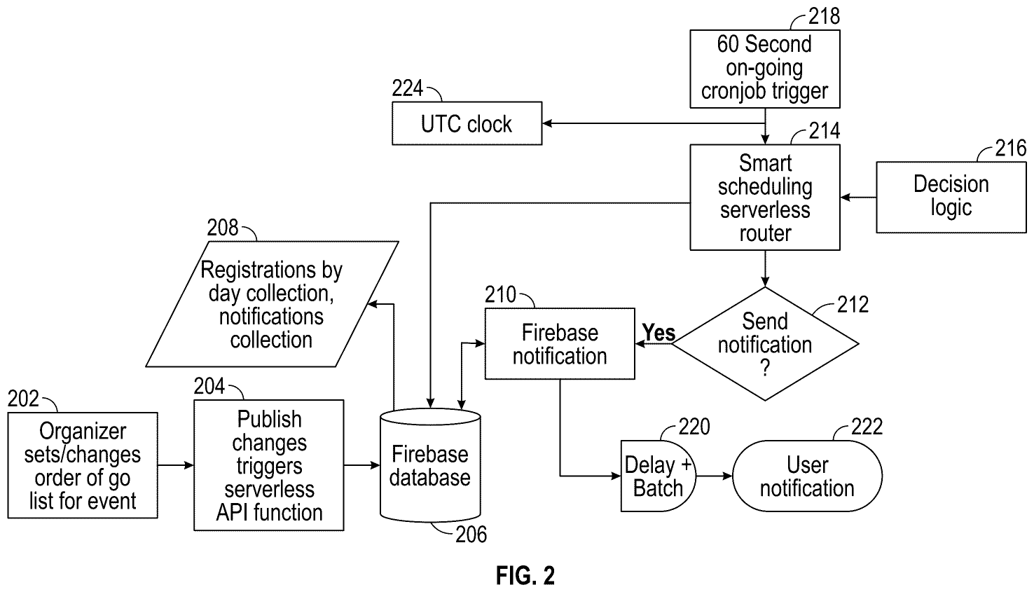

FIG. 2 illustrates a system diagram 200 of an event management and notification system. The system includes an event organizer interface 202 where an organizer sets or changes the order of go list for an event. When changes are made, a publish changes trigger 204 activates a serverless API function.

The system utilizes a database 206 (e.g., firebase database) for data storage. The database 206 includes data collections 208, which comprise registrations by day collection and notifications collection. These collections store data related to event registrations and notifications, respectively. The registrations collection may include data such as rider IDs, their entry classes, and the order of go array along with ride time in UTC. The notifications collection may store data related to the notifications sent to the users.

A smart scheduling serverless router 214 is a central component of the system. It receives input from a cronjob trigger 218, which activates every 60 seconds. The router 214 also interfaces with a decision logic module 216 and a UTC clock 224 for time reference. The decision logic module 216 provides the logic for determining whether a notification is warranted and to which user ID the specific notification needs to be sent. The UTC clock 224 provides a time reference for the system, ensuring that notifications are sent at the correct times.

The system employs a delay and batch module 220 to process notifications before they are sent to users. This module ensures that notifications are not sent immediately upon a change in the event schedule. Instead, it introduces a delay and batches multiple notifications together, reducing the number of notifications sent and preventing users from being overwhelmed with notifications. The delay and batch module 220 may assigns weights to different variables in order to know when and how to adjust notifications.

The system includes a cronjob trigger 218 that activates the smart scheduling serverless router every 60 seconds. This trigger ensures that the system regularly checks for changes in the event schedule and updates the notifications accordingly.

In some cases, the system may include a notification service 210, such as a firebase notification service. This service is responsible for delivering the notifications to the users. The notifications may be delivered as push notifications to the user devices, informing the users of changes in the event schedule.

In some aspects, the system may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

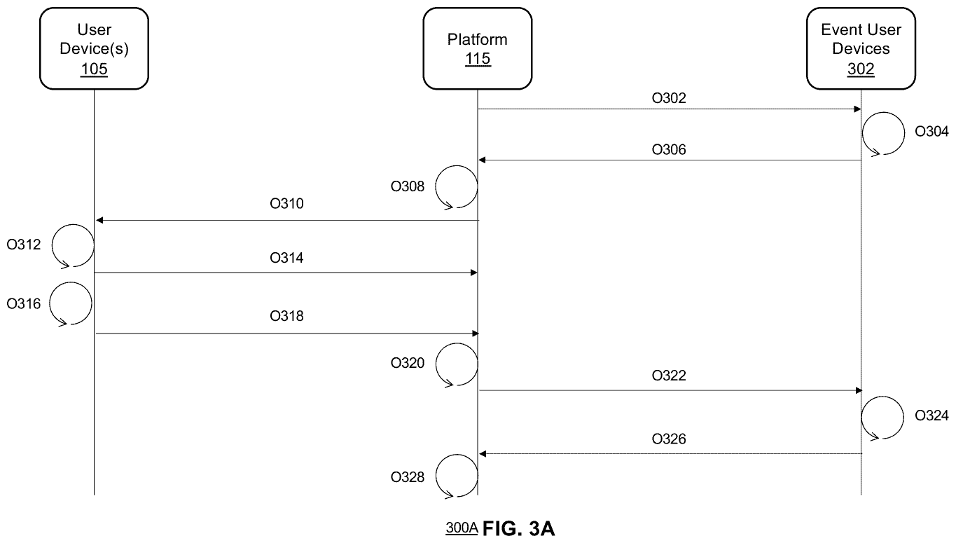

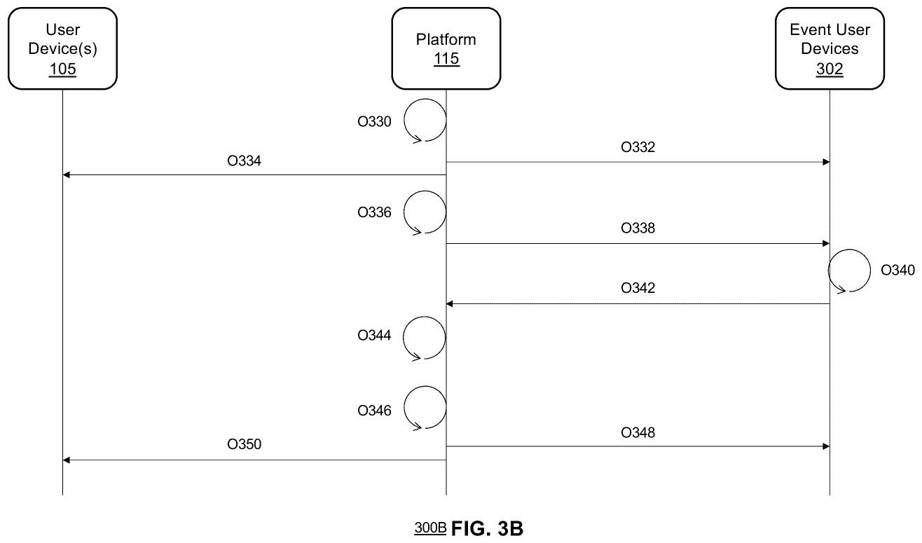

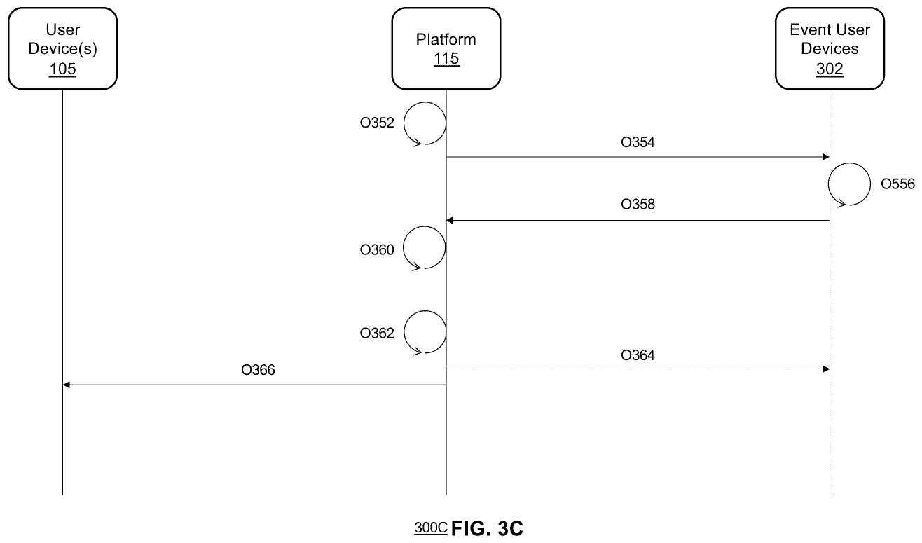

FIG. 3A illustrates a sequence diagram 300A of a system for managing event configurations and participant data. FIG. 3B illustrates a sequence diagram 300B for a process of generating and transmitting targeted push notifications, including how the system handles changes to event schedules and republishing of updated event data. FIG. 3C illustrates a sequence diagram 300C for a process of updating and notifying users about changes in a global event ordering system. The system comprises user devices 105, a platform 115, and event user devices 302.

The system comprises user devices 105, a platform 115, and event user devices 302. The event user devices 302 may include one or more of the event organizer devices 110, the vendor devices 120, and/or the governing organization devices 125.

The sequence begins with operation O302, where the platform 115 transmits event configuration interfaces to the event user devices 302. These interfaces may be designed to facilitate the collection of event configuration data, which includes data regarding a plurality of events, locations, and a time-location mapping of events to specific time slots.

In operation O304, the event user devices 302 obtain event configuration data via these interfaces. This data may be used to set up the events, determine their locations, and schedule them at specific times. The event configuration data is then transmitted back to the platform 115 in operation O306. This allows the platform 115 to store and process the event configuration data, facilitating the management of the events.

In operation O308, the platform 115 generates registration user interfaces and participant user interfaces. These interfaces may be designed to facilitate the collection of participant data and event-participant data. The participant data may include data regarding a plurality of riders, horses, and trainers, while the event-participant data may include data regarding the selection of events, riders, horses, and trainers for the events.

In operation O310, the platform 115 transmits these user interfaces to the user devices 105. The users may interact with these interfaces to provide their participant data and event-participant data. In operation O312, the user devices 105 obtain participant data via the participant user interfaces. This data may be used to identify the participants, their horses, and their trainers.

In operation O314, the user devices 105 transmit the participant data to the platform 115. This allows the platform 115 to store and process the participant data, facilitating the management of the participants. In operation O316, the user devices 105 obtain event-participant data via the registration user interfaces. This data may be used to determine the events in which the participants will participate, as well as the riders, horses, and trainers for these events.

The event-participant data is then transmitted to the platform 115 in operation O318. This allows the platform 115 to store and process the event-participant data, facilitating the management of the events and the participants. In some aspects, the system may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

The sequence diagram 300A continues with the generation and functionality of the event ordering user interface. In operation O320, the platform 115 generates the event ordering user interface in response to a request to view it for a first event. The event ordering user interface is configured to manage the order of participants in an event. It populates participants registered for the first event and automatically orders them.

In some cases, the event ordering user interface may also be configured to detect conflicts with other events. For instance, it may identify instances where a participant is scheduled to participate in two different events at the same time. The interface may then re-order the participants in the order to resolve these conflicts.

In operation O322, the platform 115 may transmit event ordering user interface and data to the event user devices 302. In operation O324, the event user devices 302 may obtain user inputs to make selections on an order for the event from available participants, and determine if a publication action is requested. In operation O326, the event user devices 302 may transmit an order for first event and the publish request to the platform 115.

In operation O328, the platform 115 may receive the order for first event and the publish request, and publish the first event data and determine targeted push notifications. This may involve making the order available to the participants, event organizers, and other stakeholders. The published order may include information such as the participants' names, their assigned times for participating in the event, and the location of the event.

In some aspects, the system may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

In operation O330, the platform 115 generates targeted push notifications. These notifications may be designed to inform participants of their place in the order when the order is published. The notifications may include information such as the participants' assigned times and locations for participating in the event.

In operations O334 and O332, these notifications are transmitted to the user devices 105 and event user devices 302, respectively. This ensures that all relevant parties, including participants and event organizers, are informed of the order of go for the event.

In operation O336, the platform 115 determines if there is a change trigger for the first event. A change trigger may occur when there is a change in the event schedule, such as a change in the order of go or the time or location of an event.

In response to a change trigger, the platform 115 generates an event ordering user interface in operation O338. This interface allows event organizers to view and modify the order of go for the event. The interface may also automatically detect conflicts with other events and re-order participants (e.g., automatically or based on user inputs) in the order to resolve these conflicts.

In operation O340, the event user devices 302 obtain user inputs and determine if a re-publish action is needed. If changes are made to the order of go, the event user devices 302 transmit an updated order for the first event and a re-publish request back to the platform 115 in operation O342.

In operation O344, the platform 115 publishes the updated first event data and determines targeted push notifications. These notifications may be designed to inform affected participants of changes in their place in the order.

In operation O346, the platform 115 generates these targeted push notifications. Finally, in operations O350 and O348, the platform 115 transmits these targeted notifications to the user devices 105 and event user devices 302, respectively. This ensures that all relevant parties are informed of any changes to the event schedule.

In some aspects, the system may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

In operation O352, the platform 115 generates a global event ordering user interface in response to a request to view it based on a change trigger condition. The global event ordering user interface is configured to retrieve orders for all events, populate segments of the interface with the orders, include conflict indicators for participants with conflicts, re-order (e.g., automatically or by user inputs) participants in the orders, and republish the orders.

The orders for all events include ordered lists of participants at specific time slots and a location for a respective event. The conflict indicators automatically highlight participants that have one or more conflicts, such as scheduling conflicts between different events. The re-ordering of participants in the orders may be based on various factors, such as the participants' preferences, availability, or performance in previous events.

In operation O354, the platform 115 transmits the global event ordering user interface and associated data to the event user devices 302. In operation O356, the event user devices 302 may then display the interface to the users, allowing them to view and interact with the updated event orders. The event user devices 302 may obtain user inputs and determine if a re-publish action is needed. If changes are made to the order of go, the event user devices 302 transmit an updated order for the changed events and a re-publish request back to the platform 115 in operation O358.

In operation O360, the platform 115 publishes the updated event data and determines targeted push notifications. These notifications may be designed to inform affected participants of changes in their place in the order. The notifications may include information such as the participants' new assigned times and locations for participating in the event.

In operation O362, the platform 115 generates these targeted push notifications. Finally, in operations O366 and O364, the platform 115 transmits these targeted notifications to the user devices 105 and event user devices 302, respectively. This ensures that all relevant parties are informed of any changes to the event schedule.

In some aspects, the system may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

In some aspects, the system may provide additional features to further enhance the management of equestrian events. For instance, the system may allow for the scheduling of breaks in the event schedule. In operation O324 of FIG. 3A, the event organizer interface 202 may include an option to add a break in the event schedule. The event organizer may specify the duration of the break and the time at which the break should occur. The system may then adjust the ride times of the participants accordingly to accommodate the break. This feature may be particularly useful in equestrian events where breaks are often needed for various reasons, such as to allow for horse care, rider rest, or event maintenance.

In some cases, the system may include a messaging feature that allows organizers to communicate with specific groups of event participants. The platform 115 may generate a messaging user interface. This interface may allow the event organizer to select a specific group of participants, such as riders, trainers, vendors, sponsors, or owners, and send them a message. The message may include information about the event, updates on the schedule, or other relevant details. This feature may facilitate efficient and targeted communication between the event organizer and the participants.

In some embodiments, the system may allow users to waive the mandatory break time between rides during the registration process. In operation O316 of FIG. 3A, the user devices 105 may obtain event-participant data via the registration user interfaces. This data may include an indication of whether the user is willing to waive the mandatory break time between rides. If the user chooses to waive the break time, the system may take this into account when scheduling the rides and generating the order of go.

In some cases, the system may include a feature to de-conflict scheduling for riders, horses, and trainers across multiple events. In some cases, the de-conflict scheduling operations may also track events for vendors, sponsors, owner, coaches, and any other user associated with the event. The platform 115 may generate a global event ordering user interface and event ordering user interface and indicate conflicts for participant on the orders of go. The global event ordering user interface may retrieve orders for all events and populate segments of the interface with the orders. The interface may also automatically include conflict indicators for the participants that have one or more conflicts. The system (e.g., automatically, as a recommendation, and/or based on user inputs) may then re-order participants in the orders to resolve these conflicts. This feature may be particularly useful in equestrian events where riders, horses, or trainers may be involved in multiple events, and conflicts in scheduling may arise.

In some aspects, these additional features may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

### 3. User Interfaces

The present disclosure relates to a system for managing equestrian events. The system may include functionalities for handling participant data, event configurations, and registration processes. The participant data may encompass information regarding riders, horses, and trainers associated with the event. Event configurations may involve details about the events, locations, and a time-location mapping of events to specific time slots. The registration process may involve the selection of events, riders, horses, owner, coaches, and trainers for the events.

In some embodiments, the system may provide an event ordering user interface for managing the order of participants in an event. The interface may be configured to automatically order participants, detect conflicts with other events, re-order participants, and publish the order for the event. Upon publishing the order, the system may push notifications to the participants informing them of their place in the order.

In response to a change trigger condition, the system may notify the user and generate a global event ordering user interface. This interface may retrieve orders for all events, populate segments of the interface with the orders, include conflict indicators for participants with conflicts, re-order participants in the orders, and republish the orders. Upon republishing the orders, the system may determine affected participants and push notifications to these participants informing them of changes in their place in the order.

The system may also include a messaging component that allows for direct and group messaging with groups of people associated with a specific event. This feature may streamline communication and provide a context-specific messaging platform for event organizers, participants, and other stakeholders.

These and other aspects of the system may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

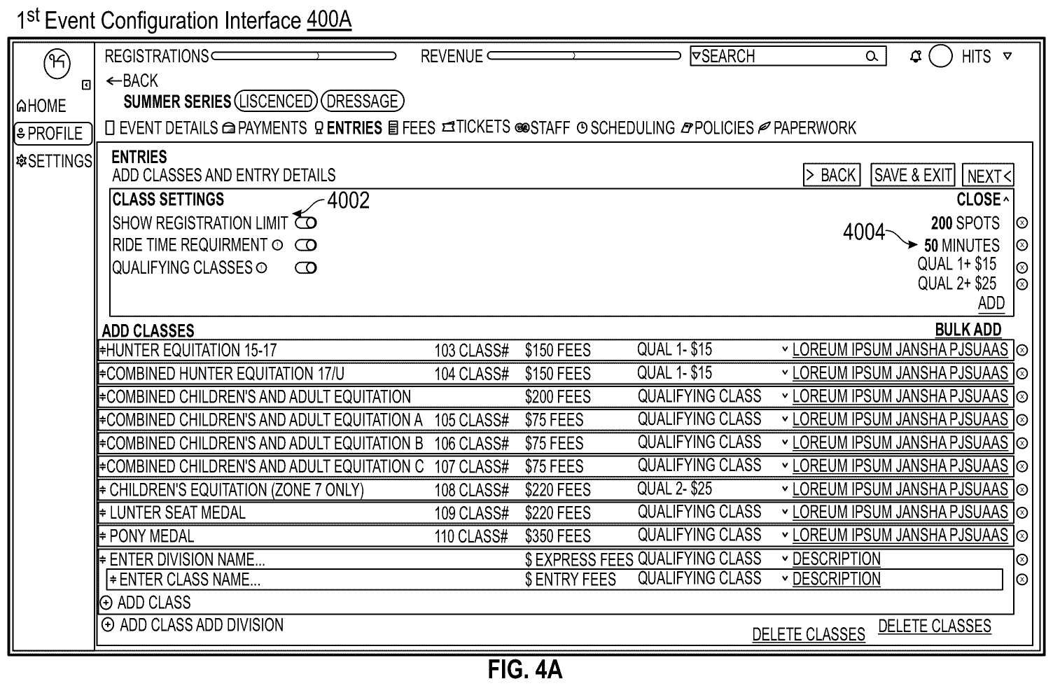

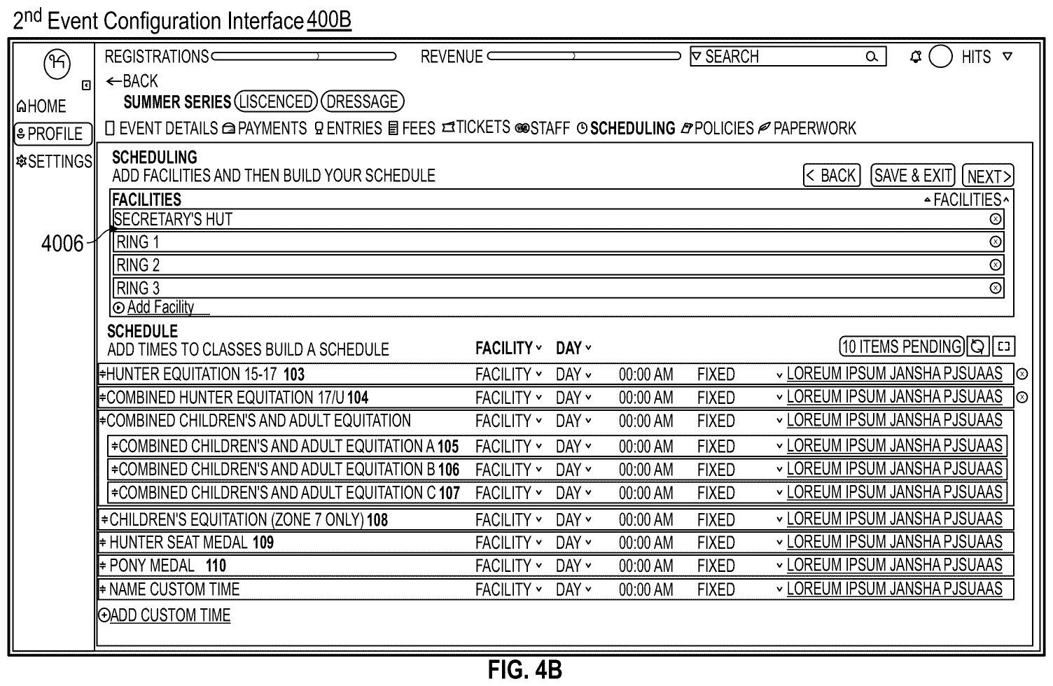

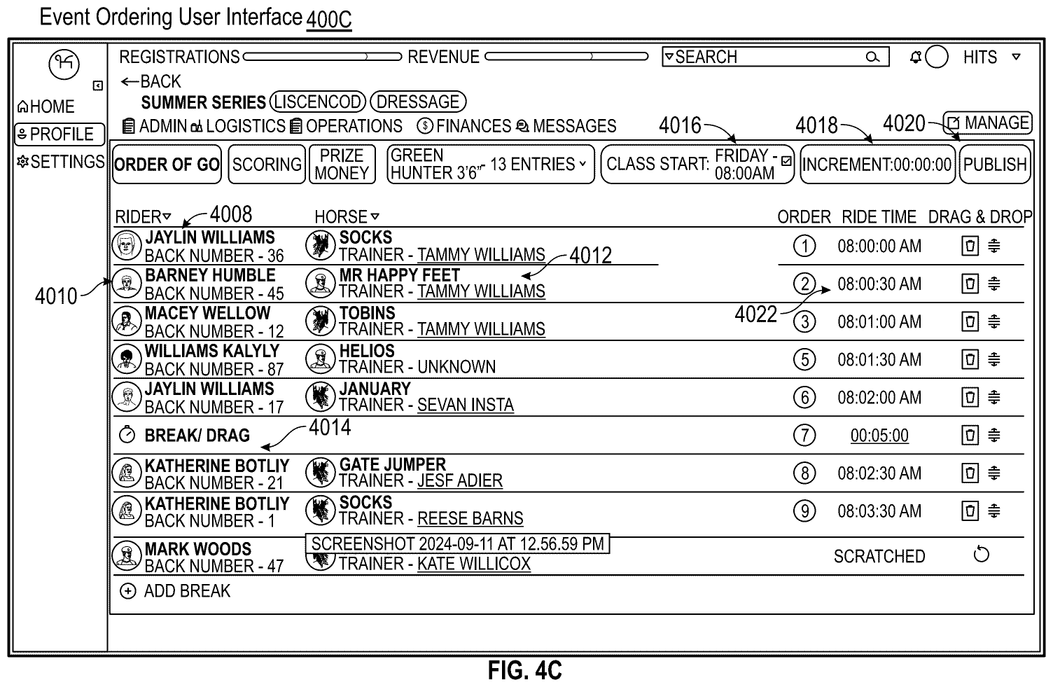

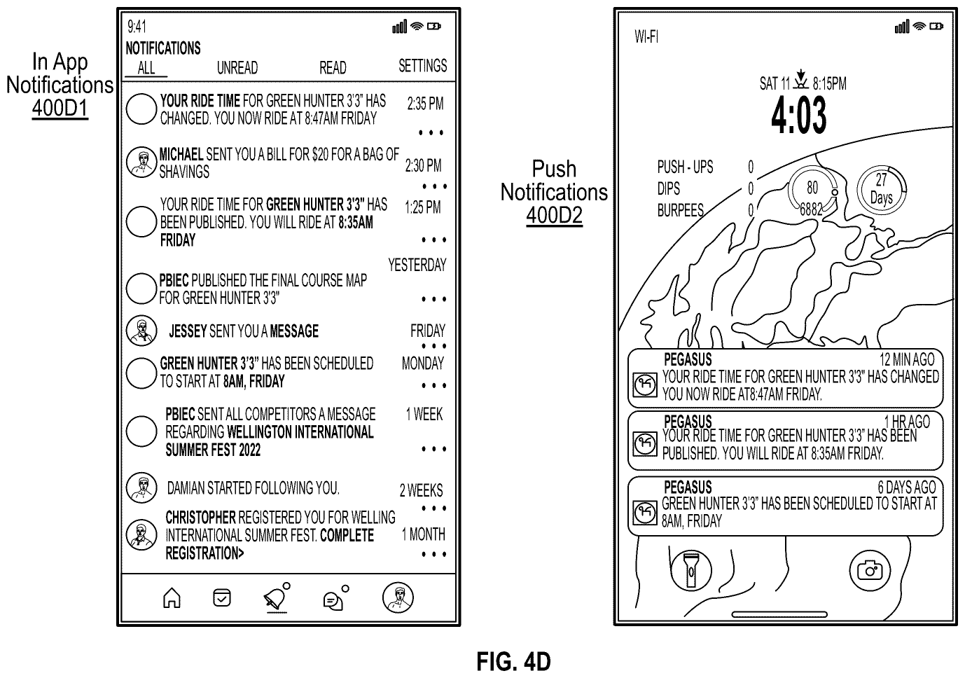

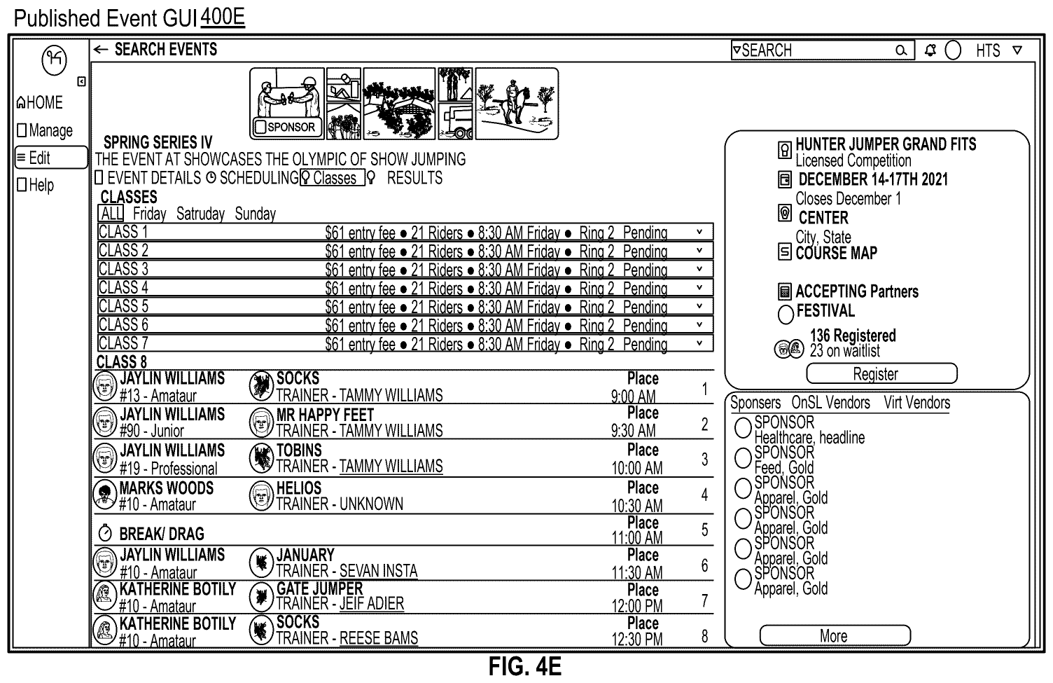

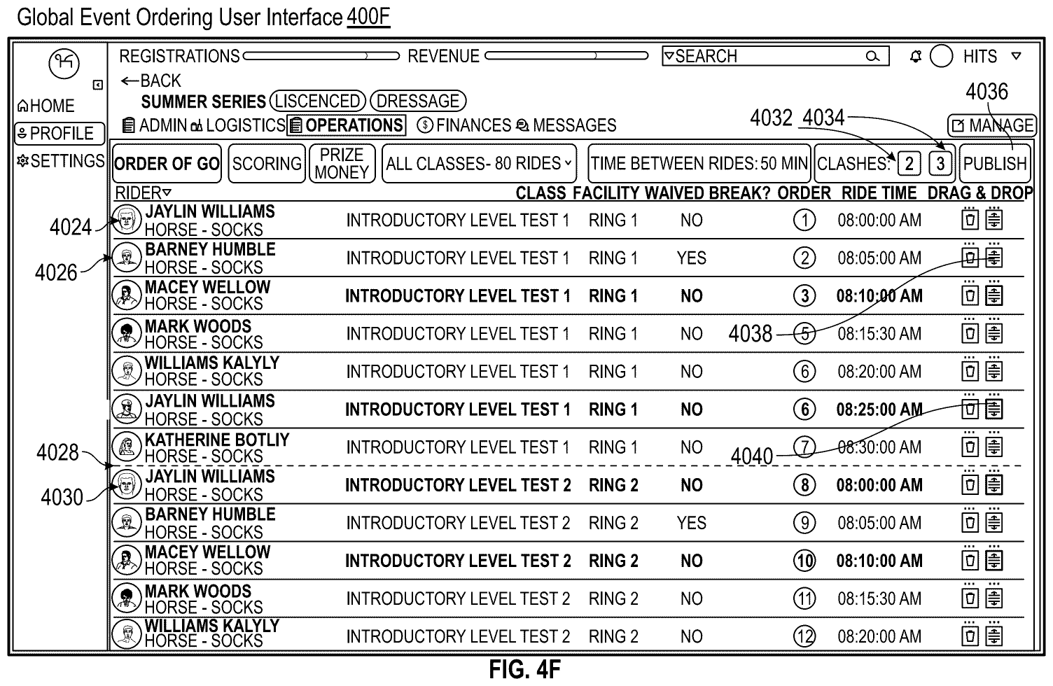

FIGS. 4A-4F illustrate event configuration interfaces, event ordering user interface, notifications, and global event ordering interface for managing equestrian events.

FIG. 4A illustrates a first event configuration interface 400A for managing equestrian events. The interface 400A includes configuration toggles 4002 and configuration parameters 4004. The configuration toggles 4002 are located on the left side of the interface and include options for “Show registration limit”, “Ride time requirement”, and “Qualifying classes”. These toggles allow the event organizer to enable or disable specific settings for the event.

The configuration parameters 4004 are displayed on the right side of the interface, corresponding to the enabled toggles. For example, when “Show registration limit” is enabled, a parameter of “200 spots” is shown. Similarly, “Ride time requirement” is set to “50 minutes”, and qualifying classes parameters are listed as “Qual 1 $15” and “Qual 2 $25”.

Below the configuration section, the interface 400A displays a list of event classes. Each class entry includes details such as the class name, number of entries, fee, and associated qualifying class or description. The interface allows for adding new classes, with options to enter division names and class names at the bottom of the list.

In some cases, the event configuration interface 400A provides a comprehensive view for organizing and managing the various aspects of an equestrian event, allowing customization of settings and easy addition of event classes. The system obtains event configuration data via event configuration interfaces, such as the event configuration interface 400A. This data may be used to set up the events, determine their locations, and schedule them at specific times.

FIG. 4B illustrates a second event configuration interface 400B for managing equestrian events. The interface 400B includes facility configuration fields 4006 for specifying different locations within the event venue. These fields may include entries for various facilities or locations, such as “Secretary's Hut”, “Ring 1”, “Ring 2”, and “Ring 3”. This allows the event organizer to define the physical layout of the event venue and assign specific locations for different events or activities.

Below the facility configuration fields 4006, the interface 400B presents a schedule section. This section contains a table with multiple rows, each representing a different event or class within the equestrian competition. The table includes columns for event names, facility assignment, day, start time, duration, and additional details.

In some aspects, the event configuration interface 400B provides dropdown menus for selecting facilities, days, and other parameters for each scheduled event. This allows for flexible configuration of the event schedule across different facilities and time slots. For instance, an event organizer may assign a specific event to “Ring 1” on “Day 1” starting at “8:00 AM” with a duration of “2 hours”. This information can be entered into the respective fields in the schedule section of the interface 400B.

In some cases, the event configuration interface 400B may also provide options for adding new events or classes. The event organizer may enter the name, facility assignment, day, start time, and duration for the new event or class in the respective fields in the schedule section. This allows the event organizer to easily expand the event schedule to accommodate additional events or classes.

In some embodiments, the event configuration interface 400B may also include options for editing or deleting existing events or classes. The event organizer may select an event or class from the schedule section and modify its details or remove it from the schedule. This provides the event organizer with the flexibility to adjust the event schedule as needed.

In some aspects, the event configuration interface 400B may provide a comprehensive tool for organizing and managing the various aspects of an equestrian event. By allowing for the specification of different facilities or locations within the event venue and flexible configuration of the event schedule, the interface 400B may facilitate efficient and user-friendly management of equestrian events.

FIG. 4C illustrates an event ordering user interface 400C for managing equestrian event participants and schedules. The interface 400C includes a participant field 4008 on the left side, displaying rider data 4010 and corresponding horse data 4012 for each entry. The rider data 4010 includes the rider's name, profile picture, and back number, while the horse data 4012 shows the horse's name and trainer information and, optionally, owner, coach, or groom.

The interface 400C features a start time field 4016 and a duration field 4018 at the top, allowing for setting the event's start time and time increments between participants. A publish action 4020 button is provided to finalize and publish the event schedule.

The main section of the interface displays an ordered list of participants with automatically calculated timeslots 4022 for each rider-horse pair. The order column shows the sequence of participants, while the ride time column displays the assigned time for each entry.

A break field 4014 is included in the list, allowing for the insertion of breaks or drag time between participants. This feature enables flexible scheduling to accommodate event-specific needs.

The interface provides drag and drop functionality for each entry, allowing for easy reordering of participants. A scratched status is also visible for entries that have been withdrawn from the event.

At the bottom of the interface, an option to add additional breaks is available, providing further flexibility in schedule management. In some cases, the event ordering user interface 400C may be generated by the system in response to a request to view it for a first event. The interface 400C is configured to populate participants registered for the first event, order (e.g., automatically or based on user inputs) populated participants in an order, automatically detect conflicts with a remainder of the events, re-order (e.g., automatically or by user inputs) participants in the order, and publish the order for the first event.

Upon publishing the order, the system may push notifications to the participants informing them of their place in the order. In some aspects, the event ordering user interface 400C provides a comprehensive tool for managing the order of participants in an equestrian event, allowing for flexible scheduling and efficient conflict resolution.

The event ordering user interface 400C further includes a publish action 4020 button. This button is provided to finalize and publish the event schedule. Upon clicking the publish action 4020 button, the system may push notifications to the participants informing them of their place in the order. This feature allows the event organizer to communicate changes in the event schedule to the participants in real time, ensuring that all participants are aware of their assigned times and can prepare accordingly.

In some aspects, the event ordering user interface 400C may be generated by the system in response to a request to view it for a first event. The interface 400C is configured to populate participants registered for the first event, order populated participants in an order, automatically detect conflicts with a remainder of the events, re-order participants in the order, and publish the order for the first event.

FIG. 4D illustrates notification interfaces for a mobile device application. The figure is divided into two parts: a notification interface 400D1 on the left and a notification screen 400D2 on the right.

The notification interface 400D1 displays an in-app notification list. It includes a header with filtering options for “All”, “Unread”, “Read”, and “Settings”. The interface shows multiple notification items, each with an icon, a brief description of the notification, and a timestamp. The notifications cover various events such as ride time changes, bills received, published ride times, course map publications, messages, and event schedules. The interface also includes navigation icons at the bottom for different sections of the application.

The notification screen 400D2 shows push notifications as they would appear on a mobile device's lock screen or notification center. The screen displays three example push notifications from the platform 115. These notifications provide information about ride time changes and event schedules, e.g., mirroring some of the content seen in the in-app notification interface 400D1.

In some aspects, the system may push notify the participants of their place in the order by push notification when the order is published. This allows the participants to be informed of their scheduled ride times and any changes that may occur. The system may also notify the user in response to a change trigger condition. This could be a change in the event schedule, a change in the order of go, or any other event-related change that may affect the participants.

In some cases, the system may push notify the affected participants of their place(s) in the order(s) that have changed. This ensures that the participants are kept up-to-date with any changes to their scheduled ride times. The notifications may be sent to the participants' user devices, informing them of their new ride times and any other relevant information.

In some embodiments, the notification interface 400D1 and the notification screen 400D2 may be part of a mobile application or wearables application for managing equestrian events. The application may provide a user-friendly interface for participants, event organizers, and other stakeholders to manage and keep track of event schedules, participant orders, and other event-related information. The application may also provide push notifications to keep users informed of any changes to the event schedule or their place in the order.

FIG. 4E illustrates a published event interface 400E for an equestrian event management system. The interface 400E displays information about a specific equestrian event. The interface includes a header section with event images, title, and description. Below the header, the interface is divided into several sections.

The left side of the interface 400E shows a list of classes for the event, with details such as class number, start time, and status. Each class entry includes options for viewing more details or managing the class.

The center of the interface 400E displays a detailed view of a selected class, showing registered participants. Each participant entry includes the rider's name, photo, horse's name and photo, and their assigned position in the class.

The right side of the interface 400E contains event information cards, including details about the event (e.g., hunter jumper event), date and location, course map, and vendor/sponsor opportunities. It also shows the number of registered participants and provides a “REGISTER” button for new registrations.

At the bottom right of the interface 400E, there is a section displaying sponsors and vendors for the event, with their logos and names listed.

In some aspects, the published event interface 400E provides a comprehensive view of the equestrian event, allowing users to access and manage various aspects of the event, including classes, participants, and event details. The interface 400E may be generated by the system in response to a request to view it for a specific event. The interface 400E is configured to display participant data, event configuration data, and event-participant data, thereby facilitating efficient and user-friendly management of equestrian events.

FIG. 4F illustrates a global event ordering interface 400F for managing multiple equestrian events. The interface 400F displays event fields 4024 and 4030, which represent different events or classes within an equestrian competition. Each event field contains participant data 4026, including rider names, horse names, and assigned ride times.

The interface 400F includes an event separation indicator 4028, which visually divides the different events. This allows for clear distinction between separate classes or competitions.

At the top of the interface, conflict counts 4032 and 4034 are displayed, indicating the number of scheduling conflicts detected across all events. These counts provide a quick overview of potential issues that need to be addressed.

The interface 400F features conflict indicators 4038 and 4040, which highlight specific participants with scheduling conflicts. These indicators appear as different indicators/markers next to the participant's information, making it easy to identify and resolve conflicts of different types.

A republish action 4036 is available, allowing the user to update and republish the event schedule after making changes or resolving conflicts.

In some aspects, the system may generate a global event ordering user interface 400F in response to a request to view it based on a change trigger condition. The global event ordering user interface 400F is configured to retrieve orders for all events, populate segments of the interface with the orders, include conflict indicators for participants with conflicts, re-order participants in the orders, and republish the orders.

Upon republishing the orders, the system may determine affected participants and push notifications to these participants informing them of changes in their place in the order. This ensures that all relevant parties are informed of any changes to the event schedule as well as their individual schedule.

In some cases, the global event ordering interface 400F may provide a comprehensive tool for managing multiple equestrian events, allowing for efficient identification and resolution of scheduling conflicts. By displaying all events and their associated participants in a single interface, the system may facilitate efficient and user-friendly management of equestrian events.

The global event ordering interface 400F may be configured to re-order participants in the orders. In some cases, the interface 400F may automatically detect conflicts with other events and re-order participants in the order to resolve these conflicts. For instance, if a participant is scheduled to participate in two different events at the same time, the interface 400F may automatically indicate, recommend, and/or adjust the order of go for the participant to avoid the scheduling conflict. This feature may be particularly useful in equestrian events where riders, horses, or trainers may be involved in multiple events, and conflicts in scheduling may arise.

In some aspects, the global event ordering interface 400F may also be configured to republish the orders. Once the participants have been re-ordered and any conflicts have been resolved, the interface 400F may republish the updated orders for the events. This may involve making the updated orders available to the participants, event organizers, and other stakeholders. The republished orders may include information such as the participants' names, their new assigned times for participating in the event, and the location of the event.

Upon republishing the orders, the system may determine affected participants and push notifications to these participants informing them of changes in their place in the order. This ensures that all relevant parties are informed of any changes to the event schedule. The notifications may be sent to the participants' user devices, informing them of their new ride times and any other relevant information.

In some cases, the global event ordering interface 400F may provide a comprehensive tool for managing multiple equestrian events, allowing for efficient identification and resolution of scheduling conflicts. By displaying all events and their associated participants in a single interface, the system may facilitate efficient and user-friendly management of equestrian events.

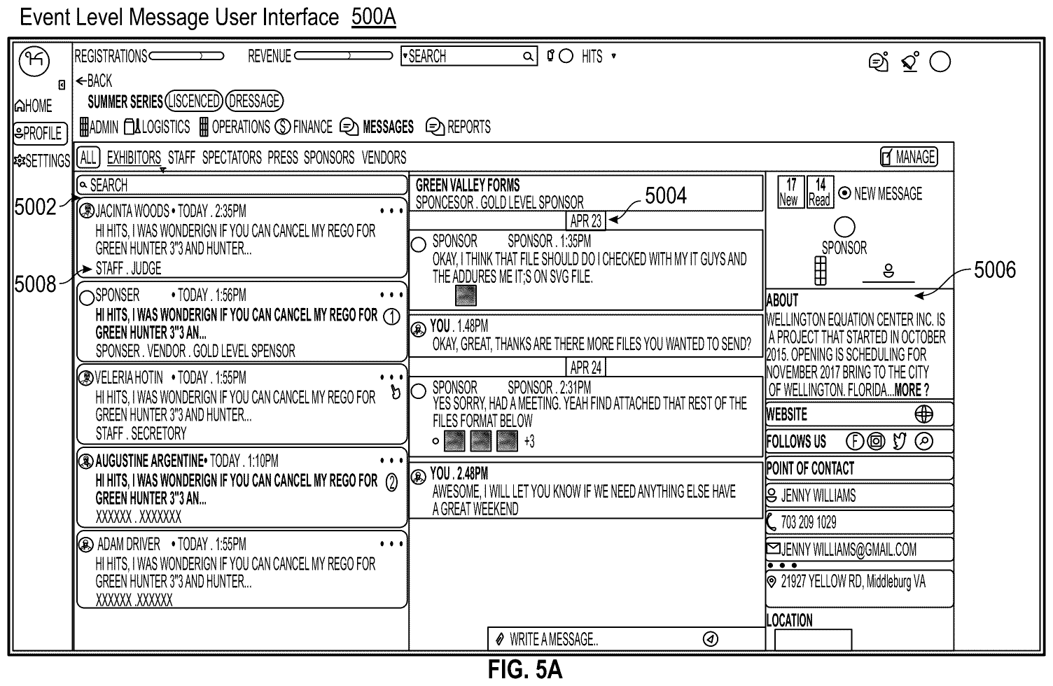

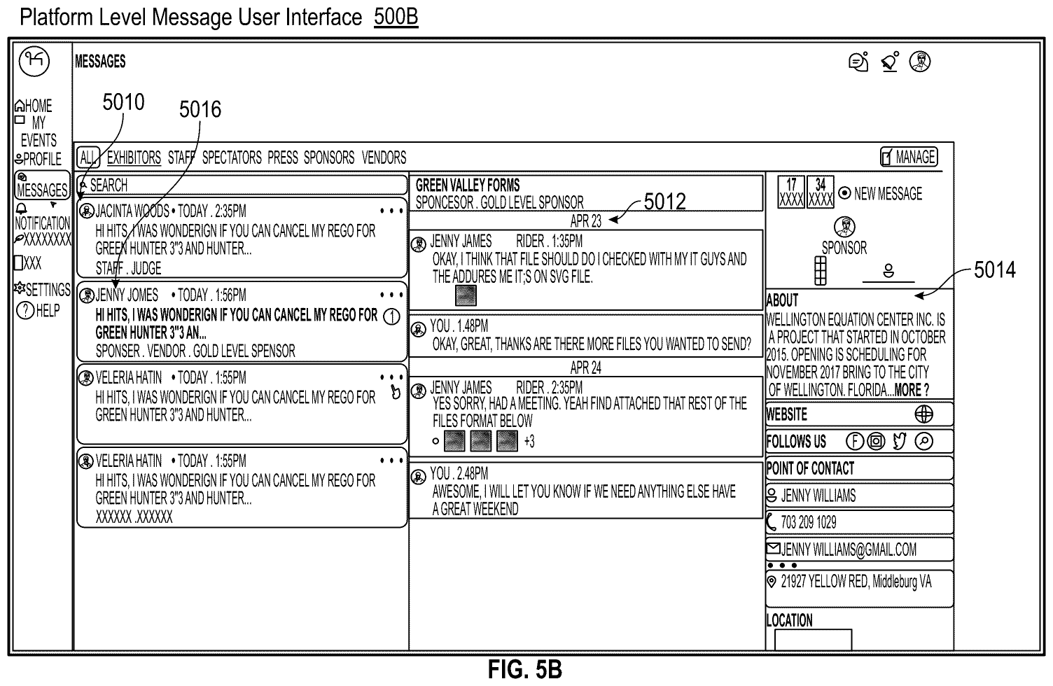

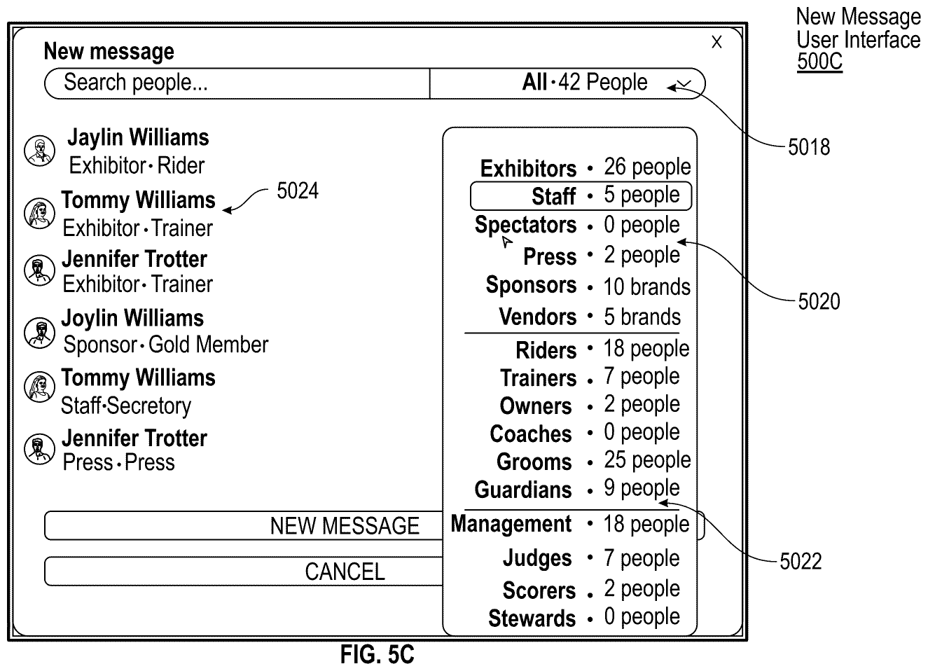

FIGS. 5A-5C illustrate message user interfaces for an equestrian event management system.

FIG. 5A illustrates an event-level message user interface 500A for an equestrian event management system. The interface 500A includes several components that facilitate communication and information display within the context of an equestrian event.

The left side of the interface 500A displays message threads 5002, which list conversations with various participants. Each thread entry includes a profile picture, name, and user role data 5008, such as “Staff-Judge” or “Sponsor, Vendor-Gold Level Sponsor”. This allows the users to easily identify the role and status of each participant in the conversation.

The central area of the interface 500A shows the displayed thread 5004, which contains the active conversation. Messages are presented in a chronological order, with sender information and timestamps. The interface allows for text-based communication as well as the sharing of attachments, as indicated by the file icons in one of the messages.

On the right side of the interface is a context window 5006. This window provides additional information about the selected conversation participant, in this case, “Green Valley Farms”. The context window 5006 includes sections for “About”, “Website”, “Follow Us”, “Point of Contact”, and “Location”, offering a comprehensive overview of the participant's profile and relevant details.

At the top of the interface, there are tabs for filtering conversations by participant type, such as “All”, “Exhibitors”, “Staff”, “Spectators”, “Press”, “Sponsors”, and “Vendors”. This allows for efficient navigation and management of different types of event-related communications.

In some aspects, the message user interface 500A integrates various elements to provide a comprehensive communication platform tailored for equestrian event management, enabling efficient interaction between organizers, participants, and other stakeholders. The context window 5006 provides additional information about the selected conversation participant, allowing the event organizer to have a better understanding of the participant's profile, role, and other relevant details. This feature may facilitate more effective and targeted communication within the context of the equestrian event.

FIG. 5B illustrates a platform-level message user interface 500B for an equestrian event management system. The interface 500B includes several components that facilitate communication and provide context for platform-level conversations.

The left side of the interface 500B displays message threads 5010, which list recent conversations with various participants. Each thread entry includes the participant's name, timestamp, and a preview of the message content. Below each name is user role and event metadata 5016, indicating the participant's role in an event and the event the message is associated with. This allows the event organizer to easily identify the role and status of each participant in the conversation.

The central area of the interface 500B shows the displayed thread 5012, which presents the active conversation. Messages are displayed in chronological order, with user avatars, timestamps, and message content visible. This allows for easy tracking of the conversation history and helps the event organizer to respond to messages in a timely and organized manner.

On the right side of the interface 500B is the context window 5014. This section provides additional information about the participant in the active conversation. It includes personal details, competition details, and competition numbers, offering quick access to relevant information during the conversation. This feature may facilitate more effective and targeted communication within the context of the equestrian event.

At the top of the interface 500B, there are tabs for filtering conversations by participant type, such as “All”, “Exhibitors”, “Staff”, “Spectators”, “Press”, “Sponsors”, and “Vendors”. This allows for efficient navigation and management of communications within the event context. By providing a dedicated messaging interface with context-specific filters and information, the system may facilitate efficient and targeted communication between the event organizer and the participants.

In some aspects, the message user interface 500B integrates various elements to provide a comprehensive communication platform tailored for equestrian event management, enabling efficient interaction between organizers, participants, and other stakeholders. The context window 5014 provides additional information about the selected conversation participant, allowing the event organizer to have a better understanding of the participant's profile, role, and other relevant details. This feature may facilitate more effective and targeted communication within the context of the equestrian event.

FIG. 5C illustrates a message interface 500C for creating a new message within an equestrian event management system. The interface 500C includes a role filter 5018 at the top, which allows users to filter recipients by their roles within the event. The role filter 5018 displays “All·<#>people” by default, indicating the total number of potential message recipients.

The interface 500C contains main role filter options 5020, which include broad categories such as Exhibitors, Staff, Spectators, Press, Sponsors, and Vendors. Each main role option displays the number of people in that category. Below the main roles, sub role filter options 5022 are presented. These provide more specific roles within the main categories, such as Riders, Trainers, Owners, Coaches, Grooms, and Guardians for the Exhibitor category, and Management, Judges, Scorers, and Stewards for the Staff category.

On the left side of the interface 500C, a user list 5024 displays individual users with their profile pictures, names, and roles. This list updates based on the selected role filters, showing users that match the chosen criteria. The message interface 500C also includes a text input area labeled “NEW MESSAGE” for composing the message, and a “CANCEL” button below it, allowing users to exit the message creation process if needed.

In some aspects, the message interface 500C provides a comprehensive tool for creating new messages within the context of an equestrian event. By allowing users to filter recipients by their roles within the event, the interface 500C facilitates targeted communication between different stakeholders. This feature may be particularly useful in equestrian events where communication needs to be tailored to specific groups of participants, such as riders, trainers, or event organizers.

In some cases, the message interface 500C may also allow users to select multiple recipients for a message. For instance, a user may select all trainers or all riders for a particular event, enabling efficient mass communication. This feature may be particularly useful for sending updates or announcements related to the event.

In some embodiments, the message interface 500C may also provide a preview of the selected recipients before the message is sent. This allows the user to confirm the recipients and make any necessary adjustments before sending the message. This feature may help to prevent miscommunication or errors in message delivery.

In some aspects, the message interface 500C may also allow users to save drafts of messages. This feature may be useful for composing complex or lengthy messages that require more time to write. The user can save their progress and return to the draft later to complete the message.

In some cases, the message interface 500C may also provide options for attaching files or links to the message. This feature may be useful for sharing additional information or resources related to the event. For example, a user may attach a course map, a schedule, or a link to a website with more information about the event.

In some embodiments, the message interface 500C may also provide options for formatting the text of the message. This feature may be useful for emphasizing certain parts of the message or making the message more readable. For example, a user may use bold or italic text, bullet points, or numbered lists to format their message.

In some aspects, these additional features of the message interface 500C may provide an efficient and user-friendly solution for managing communication within the context of an equestrian event. The system may provide functionalities for handling participant data, event configurations, and registration processes, among others, thereby facilitating efficient and user-friendly management of equestrian events.

In some embodiments, the system may include at least one memory configured to store instructions and at least one processor executing the instructions to perform operations. These operations may include obtaining participant data, event configuration data, and event-participant data, among others.

The participant data may be obtained via participant user interfaces from a plurality of user devices. The participant data may include data regarding a plurality of riders, horses, owners, coaches, grooms, and trainers, and the like, associated with the event. For instance, the participant data may include the rider's name, profile picture, back number, the horse's name, and the trainer's information. This data may be used to identify the participants, their horses, and their trainers.

The system may also obtain event configuration data via event configuration interfaces. The event configuration data may include data regarding a plurality of events, locations, and a time-location mapping of events to specific time slots. For example, the event configuration data may include the event's name, description, location, start time, duration, and the order of participants. This data may be used to set up the events, determine their locations, and schedule them at specific times.

In addition, the system may obtain event-participant data via registration user interfaces. The event-participant data may include data regarding the selection of events, the rider for the events, the horse for the events, and the trainer for the events. For instance, during the registration process, the users may select the events they wish to participate in, the riders for these events, the horses for these events, the owners of the horses, and the trainers for these events. This data may be used to determine the events in which the participants will participate, as well as the riders, horses, and trainers for these events.

In response to the order being published, the system may push notify the participants of their place in the order by push notification. This allows the participants to be informed of their scheduled ride times and any changes that may occur. The system may also notify the user in response to a change trigger condition. This could be a change in the event schedule, a change in the order of go, or any other event-related change that may affect the participants.

In response to the orders being republished, the system may determine affected participants. The affected participants may be those whose place in the order has changed due to the republishing of the orders. The system may then push notify the affected participants of their place(s) in the order(s) that have changed by push notification. This ensures that all relevant parties are informed of any changes to the event schedule. The notifications may be sent to the participants' user devices, informing them of their new ride times and any other relevant information.

### 4. Flowcharts

The present disclosure provides a system for managing equestrian events. The system may include functionalities for handling participant data, event configurations, and registration processes. The participant data may encompass information regarding stakeholders, including, but not limited to, riders, horses, owners, coaches, grooms, and trainers, and the like, associated with the event. Event configurations may involve details about the events, locations, and a time-location mapping of events to specific time slots. The registration process may involve the selection of events, riders, horses, coaches, owners, and trainers for the events.

In some embodiments, the system may provide an event ordering user interface for managing the order of participants in an event. The interface may be configured to automatically order participants, detect conflicts with other events, re-order participants, and publish the order for the event. Upon publishing the order, the system may push notifications to the participants informing them of their place in the order.

In response to a change trigger condition, the system may notify the user and generate a global event ordering user interface. This interface may retrieve orders for all events, populate segments of the interface with the orders, include conflict indicators for participants with conflicts, re-order participants in the orders, and republish the orders. Upon republishing the orders, the system may determine affected participants and push notifications to these participants informing them of changes in their place in the order.

The system may also include a messaging component that allows for direct and group messaging with groups of people associated with a specific event. This feature may streamline communication and provide a context-specific messaging platform for event organizers, participants, and other stakeholders.

These and other aspects of the system may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

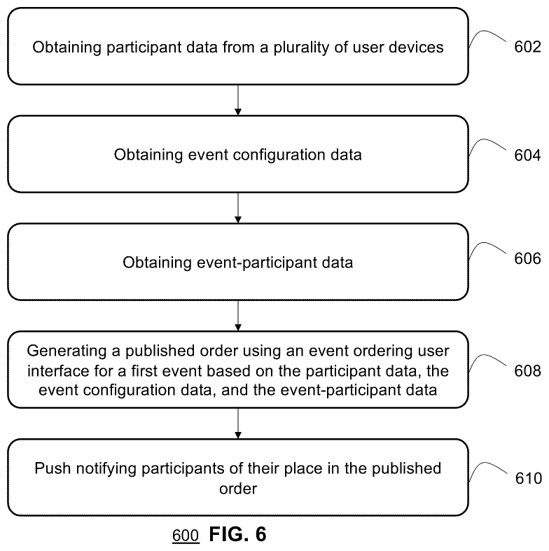

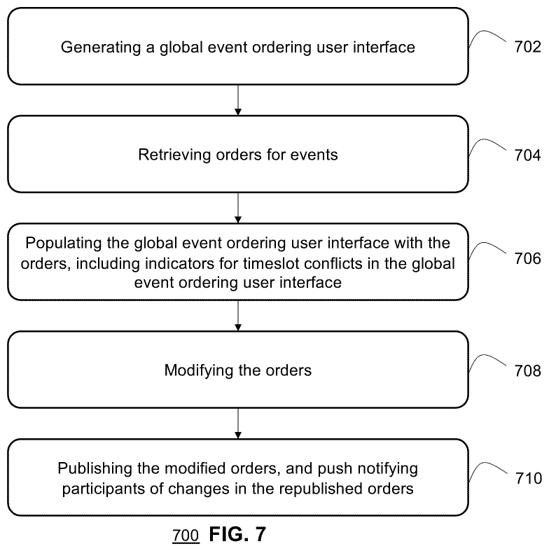

FIGS. 6 and 7 illustrate flowcharts for managing event participation and notifications.

FIG. 6 illustrates a flowchart for a method 600 of managing event participation and notification. The method 600 begins with step 602, where participant data is obtained from a plurality of user devices via participant user interfaces. The participant data may include data regarding a plurality of riders, horses, coaches, owners and trainers associated with the event. For instance, the participant data may include the rider's name, profile picture, back number, the horse's name, and the trainer's information. This data may be used to identify the participants, their horses, and their trainers.

Following this, step 604 involves obtaining event configuration data via event configuration interfaces. The event configuration data may include data regarding a plurality of events, locations, and a time-location mapping of events to specific time slots. For example, the event configuration data may include the event's name, description, location, start time, duration, and the order of participants. This data may be used to set up the events, determine their locations, and schedule them at specific times.

The process then moves to step 606, where event-participant data is obtained via registration user interfaces. The event-participant data may include data regarding the selection of events, the rider for the events, the horse for the events, the owner of the horses, the grooms, guardians, and the trainer for the events. For instance, during the registration process, the users may select the events they wish to participate in, the riders for these events, the horses for these events, owners, coaches and the trainers for these events. This data may be used to determine the events in which the participants will participate, as well as the riders, horses, owners, coaches and trainers for these events.

In some aspects, the method 600 integrates data from multiple sources to create and communicate event schedules efficiently. The method 600 may provide functionalities for handling participant data, event configurations, and registration processes, among others, thereby facilitating efficient and user-friendly management of equestrian events.

The system may further include operations for conflict detection and order modification. In some cases, the event ordering user interface generated in step 608 may be configured to automatically detect conflicts with a remainder of the events when ordering participants. These conflicts may arise when a participant is scheduled to participate in two or more events that overlap in time or location. The system may use various algorithms or rules to detect such conflicts, taking into account factors such as the duration of each event, the location of each event, and the travel time between different locations.

Upon detecting a conflict, the system may re-order (e.g., automatically and/or based on user inputs) the participants in the order to resolve the conflict. This re-ordering may involve adjusting the time slots or locations of the conflicting events, or changing the order of participants in the events. The system may use various strategies to re-order the participants, such as prioritizing participants based on their performance in previous events, their preferences, or other criteria.

Once the participants have been re-ordered and any conflicts have been resolved, the system may publish the order for the first event in step 610. This may involve making the order available to the participants, event organizers, and other stakeholders. The published order may include information such as the participants' names, their assigned times for participating in the event, and the location of the event.

Upon publishing the order, the system may push notify the participants of their place in the order by push notification. This allows the participants to be informed of their scheduled ride times and any changes that may occur. The push notifications may be sent to the participants' user devices, such as smartphones, wearables (e.g., smart watches) or tablets, and may include information such as the participants' new ride times, the location of their events, and any other relevant information.

In some aspects, the method 600 provides an efficient and user-friendly solution for managing equestrian events, addressing the unique challenges and requirements of such events. The method 600 may provide functionalities for handling participant data, event configurations, and registration processes, among others, thereby facilitating efficient and user-friendly management of equestrian events.

FIG. 7 illustrates a flowchart for a method 700 of managing global event ordering. The method 700 begins with step 702, where the system generates a global event ordering user interface in response to a request to view it based on a change trigger condition. The global event ordering user interface may be configured to retrieve orders for all events, populate segments of the interface with the orders, include conflict indicators for participants with conflicts, re-order participants in the orders, and republish the orders.

In step 704, the system retrieves orders for all events. The orders may include ordered lists of participants at specific time slots and a location for a respective event. The system may retrieve these orders from a database or other data storage system where the event data is stored. The retrieved orders may include information such as the participants' names, their assigned times for participating in the event, and the location of the event.

In some aspects, the global event ordering user interface may be configured to display a grid view showing all events across different facilities and time slots. This grid view may provide a comprehensive overview of all the events, allowing the user to easily visualize the event schedule and identify any potential conflicts or scheduling issues.

In some cases, the system may use different types of indicators to represent different types of conflicts. For example, the system may use a first type of indicator for hard conflicts indicating overlapping events for the same participant and/or events that violate required break times. The system may also use a second type of indicator for allowable soft conflicts of break times that have been approved by a rider or trainer. These conflict indicators may be visually differentiated in the global event ordering user interface, allowing the user to easily identify and address any conflicts.

In some embodiments, the system may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

In step 706, the system populates segments of the global event ordering user interface with the orders for all the events. This may involve displaying the orders in a grid view or other suitable format, allowing the user to easily view and navigate the orders. The system may also automatically include conflict indicators for the participants that have one or more conflicts. These conflict indicators may be visually differentiated in the global event ordering user interface, allowing the user to easily identify and address any conflicts.

In step 708, the system modifies the orders based on user input or other factors. This may involve re-ordering participants in the orders, adjusting time slots, or making other changes to the orders. The system may use various strategies to modify the orders, such as prioritizing participants based on their performance in previous events, their preferences, or other criteria.

In step 710, the system republishes the orders. This may involve making the updated orders available to the participants, event organizers, and other stakeholders. The republished orders may include information such as the participants' names, their new assigned times for participating in the event, and the location of the event.

Upon republishing the orders, the system may determine affected participants and push notify these participants of changes in the republished orders. This ensures that all relevant parties are informed of any changes to the event schedule. The notifications may be sent to the participants' user devices, informing them of their new ride times and any other relevant information.

In some aspects, the method 700 provides an efficient and user-friendly solution for managing equestrian events, addressing the unique challenges and requirements of such events. The method 700 may provide functionalities for handling participant data, event configurations, and registration processes, among others, thereby facilitating efficient and user-friendly management of equestrian events.

In some embodiments, the system may further include operations for obtaining additional participant data. This additional participant data may include data regarding owners, coaches, and/or grooms associated with riders or horses. The participant data may be obtained via participant user interfaces from a plurality of user devices.

For instance, the participant data may include the owner's name, contact information, and the horse(s) they own. This data may be used to identify the owners and their associated horses. Similarly, the participant data may include the coach's name, contact information, and the rider(s) they coach. This data may be used to identify the coaches and their associated riders.

Furthermore, the participant data may include the groom's name, contact information, and the horse(s) they groom. This data may be used to identify the grooms and their associated horses.

In some cases, the system may use this additional participant data to facilitate more efficient and effective management of equestrian events. For example, the system may use the owner data to ensure that all horses are properly accounted for and that their owners are informed of any changes to the event schedule.

Similarly, the system may use the coach data to ensure that all riders are properly prepared for their events and that their coaches are informed of any changes to the event schedule.

Additionally, the system may use the groom data to ensure that all horses are properly cared for and that their grooms are informed of any changes to the event schedule.

In some aspects, these additional features of the system may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

In some embodiments, the system may store the event configuration data in a hierarchical data structure. This hierarchical data structure may include multiple levels that represent different aspects of the event configuration. For instance, the hierarchical data structure may include a top level representing the plurality of events. Each event may be associated with a second level representing the plurality of locations for each event. Each location may be associated with a third level representing time slots for each location. Each time slot may be associated with a fourth level representing participant slots for each time slot. In some cases, the hierarchical data structure may further include a fifth level representing individual participants assigned to each participant slot. The individual participants may include riders, horses, coaches, owners, grooms, guardians, vendors, sponsors, spectators, and/or trainers.

The system may traverse the hierarchical data structure to detect conflicts between participant assignments across different events, locations, and time slots. For example, the system may identify instances where a participant is scheduled to participate in two different events at the same time or location. The system may use various algorithms or rules to detect such conflicts, taking into account factors such as the duration of each event, the location of each event, and the travel time between different locations.

The system may also update the hierarchical data structure in real-time as changes are made to event schedules or participant assignments. For instance, if a participant is added to or removed from an event, the system may update the corresponding participant slot in the hierarchical data structure. Similarly, if the time or location of an event is changed, the system may update the corresponding time slot or location in the hierarchical data structure.

In some aspects, the system may query the hierarchical data structure to generate views for the event ordering user interface and the global event ordering user interface. The system may retrieve the orders for all events from the hierarchical data structure and populate the interfaces with these orders. The system may also automatically include conflict indicators for participants with conflicts in the interfaces. These conflict indicators may be visually differentiated in the interfaces, allowing the user to easily identify and address any conflicts.

In some cases, the hierarchical data structure may be stored in a database or other data storage system. The system may use various data management techniques to efficiently store, retrieve, and update the data in the hierarchical data structure. For example, the system may use indexing, partitioning, or compression techniques to optimize the performance of the data storage system.

In some embodiments, the hierarchical data structure may provide a flexible and efficient way to manage event configurations and participant assignments. By organizing the data in a hierarchical manner, the system may facilitate efficient conflict detection, real-time updates, and generation of user interface views. This may provide an efficient and user-friendly solution for managing equestrian events, addressing the unique challenges and requirements of such events.

In some embodiments, the system may provide advanced conflict management capabilities to handle the complex scheduling requirements of equestrian events. These capabilities may include event dependencies, multi-level notifications, conflict detection methods, severity assessment, and automated resolution suggestions.

Event dependencies may be tracked using the hierarchical data structure. For instance, the system may identify dependencies between different events, such as a rider participating in multiple events, a horse being used in multiple events, or a trainer/coach coaching multiple riders in different events. The system may use the hierarchical data structure to track these dependencies and take them into account when scheduling events and assigning participants to time slots.

The system may also provide multi-level notifications based on changes detected at any level of the hierarchical data structure. For example, if a change is made to an event at the top level of the hierarchy, such as changing the location of the event, the system may generate notifications for all participants associated with that event. Similarly, if a change is made at a lower level of the hierarchy, such as changing the time slot of a participant, the system may generate notifications for that participant and any other participants affected by the change.

Conflict detection methods may be used to identify potential scheduling conflicts. For example, the system may identify overlapping time slots for events assigned to the same participant. The system may also determine if sufficient travel time exists between consecutive events for a participant at different locations. Furthermore, the system may flag events that violate predefined break time requirements for participants. These conflict detection methods may help to ensure that the event schedule is feasible and that participants are able to attend their assigned events.

Severity assessment may be used to assign a severity level to each detected conflict. The severity level may be based on various factors, such as the duration of the overlap between events, the distance between locations, or the amount of time by which a break time requirement is violated. The system may visually differentiate conflict indicators in the global event ordering user interface based on the assigned severity levels. This may allow the user to easily identify and prioritize the resolution of conflicts.

Automated resolution suggestions may be provided to help resolve detected conflicts. For example, the system may suggest alternative time slots or event assignments that would resolve the conflict. The system may display these suggested alternatives in the global event ordering user interface, allowing the user to easily view and consider the suggestions. If the user accepts a suggested alternative, the system may automatically update the event assignments and time slots accordingly.

In some aspects, these advanced conflict management capabilities may provide an efficient and user-friendly solution for managing the complex scheduling requirements of equestrian events. The system may provide functionalities for handling participant data, event configurations, and registration processes, among others, thereby facilitating efficient and user-friendly management of equestrian events.

In some embodiments, the system may include additional features for real-time conflict detection, customizable break slots, and dynamic schedule adjustments. These features may further enhance the management of equestrian events by providing more flexibility and responsiveness in scheduling and conflict resolution.

In some cases, the system may monitor real-time updates to event schedules and participant assignments. As changes are made, the system may dynamically recalculate conflicts based on the updated data. For instance, if a participant is added to or removed from an event, or if the time or location of an event is changed, the system may automatically detect any resulting conflicts. This real-time conflict detection may allow for immediate identification and resolution of scheduling issues, ensuring that the event schedule remains feasible and efficient. In some cases, the platform may integrate with hardware/sensors to track and report data. For instance, the platform may interact with and gather data from tracking chips in lips of horses, and/or lasers that will detect when a horse crosses a line. This will record whether horse enters, e.g., the ring and leaves, and thus affect recording of live updates of schedule and progress.

In some aspects, the system may provide an option to add a break slot with a customizable duration to the order of participants in an event. The event organizer may specify the duration of the break and the time at which the break should occur. Upon receiving this input, the system may automatically adjust the time slots for participants following the added break slot. This may involve shifting the time slots for subsequent participants based on the duration of the break. This feature may provide additional flexibility in scheduling, allowing for breaks to be inserted as needed to accommodate event-specific needs, such as allowing for horse care, rider rest, or event maintenance.

In some embodiments, the system may detect potential conflicts caused by the addition of the break slot. For example, if the addition of a break results in overlapping time slots for different participants, the system may flag this as a conflict. The system may then provide options for resolving the conflict, such as suggesting alternative time slots or event assignments. This feature may help to ensure that the addition of breaks does not disrupt the overall event schedule or cause conflicts for participants.

In some cases, the system may dynamically adjust the event schedule in response to changes in the event or participant data. For instance, if a participant is moved in the order of go, the system may automatically update the time slots for all subsequent participants. Similarly, if a participant cancels their participation in an event, the system may remove them from the order and adjust the time slots for the remaining participants. These dynamic schedule adjustments may allow for more responsive and efficient management of the event schedule, accommodating changes as they occur and ensuring that the schedule remains up-to-date and accurate.

In some aspects, these additional features may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

In some embodiments, the system may provide additional features for managing event schedules, including handling break slots, real-time modifications, and time-sensitive changes. For instance, the system may allow user input to drag and drop the added break slot to a different position in the order. This feature may provide additional flexibility in scheduling, allowing for breaks to be inserted as needed to accommodate event-specific needs, such as allowing for horse care, rider rest, or event maintenance. The system may automatically adjust the time slots for participants following the added break slot, shifting the time slots for subsequent participants based on the duration of the break.

In some cases, the system may generate notifications for participants affected by the addition of the break slot. These notifications may be sent to the participants' user devices, informing them of their new ride times and any other relevant information. This feature may help to ensure that all participants are aware of any changes to the event schedule, allowing them to adjust their plans accordingly.

In some aspects, the system may receive a request to modify the order for the first event after the event has started. This feature may be particularly useful in situations where unexpected changes occur during the event, such as weather delays or equipment malfunctions. Upon receiving such a request, the system may display a warning message indicating that changes are being made to an ongoing event. The system may then update the order for the first event, adjusting the time slots for participants based on the modification.

In some embodiments, the system may determine a current progress status of the first event and adjust subsequent time slots based on the modification. This feature may allow for more accurate and responsive scheduling, ensuring that the event schedule remains up-to-date and accurate even in the event of unexpected changes. The system may then push notify the affected participants of their updated time slots, ensuring that all relevant parties are informed of any changes to the event schedule.

In some cases, the system may detect a request to modify the order within a predetermined threshold period before the scheduled start time of the first event. This feature may be particularly useful in situations where last-minute changes are necessary, such as when a participant is unable to attend the event or when an event needs to be rescheduled due to unforeseen circumstances. Upon detecting such a request, the system may display a warning message indicating proximity to the event start time. The system may then implement the modification to the order, generate a priority notification for all participants in the first event, and push notify the participants of the modified order using the priority notification. This feature may help to ensure that all participants are informed of any last-minute changes to the event schedule, allowing them to adjust their plans accordingly.

In some embodiments, the system may include capabilities for real-time event monitoring, automatic time slot adjustments, and role-based push notification customization. These features may further enhance the management of equestrian events by providing more flexibility and responsiveness in scheduling and conflict resolution.

In some cases, the system may monitor real-time progress of the first event. This feature may allow the system to track the current status of the event, including the progress of individual participants, the status of different events, and any changes or disruptions that may occur during the event. The system may use various methods to monitor the real-time progress of the event, such as tracking the start and end times of each participant's ride (e.g., using user interfaces and/or sensor data from Lip chips and lasers), monitoring the status of different facilities or locations, or receiving updates from event organizers or other stakeholders.

Upon detecting a deviation from the published order during the first event, the system may automatically adjust subsequent time slots in the order based on the detected deviation. This feature may allow the system to dynamically update the event schedule in response to real-time changes, ensuring that the schedule remains accurate and up-to-date. The system may use various algorithms or rules to adjust the time slots, taking into account factors such as the duration of each event, the location of each event, and the travel time between different locations.

In some aspects, the system may configure the push notification based on a role of each participant. The role of each participant may include rider, trainer, coach, owner, guardian, spectator, groom, event organizer, judge, or staff member. This feature may allow the system to customize the content and delivery of the push notifications based on the specific needs and responsibilities of each role. For example, riders may receive notifications about their ride times and locations, coaches, grooms, owners, trainers may receive notifications about the performance of their riders, event organizers may receive notifications about the overall progress of the event, judges may receive notifications about the results of different events, and staff members may receive notifications about their assigned tasks or responsibilities.

In some cases, the system may customize the content of the push notification based on the determined role. This feature may allow the system to provide relevant and useful information to each participant, enhancing the user experience and improving the efficiency of the event management process. The system may include role-specific information in the push notification, such as the participant's assigned times and locations for participating in the event, the results of different events, or any other relevant information.

In some embodiments, the system may set a priority level for the push notification based on the determined role. This feature may allow the system to control the delivery of the push notifications, ensuring that important notifications are delivered promptly and that less important notifications do not overwhelm the participants. The system may use various methods to set the priority level, such as assigning higher priority levels to notifications about changes in the event schedule or results of events, and assigning lower priority levels to notifications about less critical information.

In some embodiments, the system may include additional features related to participant grouping, handling event cancellations and order changes, conflict detection, and notification processes for affected participants.

For instance, the system may group affected participants based on their roles. The roles may include riders, trainers, event organizers, judges, staff members or additional roles. This feature may allow the system to send batch notifications to each group of participants. For example, if a change in the event schedule affects all riders, the system may send a batch notification to all riders informing them of the change. This feature may enhance the efficiency of the communication process and ensure that all relevant parties are informed of any changes to the event schedule.

In some cases, the change trigger condition may comprise a participant cancelling an event. For example, if a rider decides to withdraw from an event, this may trigger a change in the event schedule. The system may then update the order to remove the participant that cancelled the event. This may involve adjusting the time slots for subsequent participants to fill the gap left by the cancelled event. The system may then republish the order and push notify the affected participants of their updated time slots.

In some aspects, the change trigger condition may comprise a participant being moved in an order and causing a conflict with their own events or events of other participants. For example, if a rider is moved to an earlier time slot in the order, this may cause a conflict if the rider is also scheduled to participate in another event at the same time. The system may detect the conflict caused by the participant being moved in the order and generate notifications for the affected participants indicating the detected conflict.

In some embodiments, the system may include a feature to automatically adjust the event schedule in response to changes in the event or participant data. For instance, if a participant is moved in the order of go, the system may automatically update the time slots for all subsequent participants. Similarly, if a participant cancels their participation in an event, the system may remove them from the order and adjust the time slots for the remaining participants. These dynamic schedule adjustments may allow for more responsive and efficient management of the event schedule, accommodating changes as they occur and ensuring that the schedule remains up-to-date and accurate.

In some cases, these additional features may provide an efficient and user-friendly solution for managing equestrian events, addressing the unique challenges and requirements of such events. The system may provide functionalities for handling participant data, event configurations, and registration processes, among others, thereby facilitating efficient and user-friendly management of equestrian events.

In some embodiments, the system may analyze the conflict caused by a participant being moved in the order of go. For instance, if a rider is moved to an earlier time slot in the order, this may cause a conflict if the rider is also scheduled to participate in another event at the same time. The system may use various algorithms or rules to analyze the conflict, taking into account factors such as the duration of each event, the location of each event, and the travel time between different locations. The system may then suggest alternative time slots or event assignments that would resolve the conflict. These suggested alternatives may be displayed in the event ordering user interface, allowing the user to easily view and consider the suggestions. If the user accepts a suggested alternative, the system may automatically update the event assignments and time slots accordingly.

In some cases, the system may notify the user in response to a change trigger condition. A change trigger condition may occur when there is a change in the event schedule, such as a change in the order of go or the time or location of an event. Upon detecting a change trigger condition, the system may generate a notification and send it to the user. The notification may include information about the change, such as the new order of go, the new time or location of the event, or any other relevant information. This feature may help to ensure that the user is informed of any changes to the event schedule, allowing them to adjust their plans accordingly.

In some aspects, the event ordering user interface may receive user input to drag and drop participants to reorder them. This feature may provide a user-friendly way for the user to adjust the order of go. The user may simply click on a participant in the order and drag them to a new position in the order. The system may then automatically update the order based on the drag and drop input. The event ordering user interface may also display a visual indicator of potential conflicts during the drag and drop operation. For example, if moving a participant to a new position in the order would cause a conflict with another participant, the interface may display a visual indicator, such as a warning icon or a color change, to alert the user to the potential conflict.

In some embodiments, the system may provide a messaging interface that enables grouping of recipients based on their role in the event. The roles may include riders, trainers, event organizers, judges, staff members, or additional roles. The messaging interface may allow the user to select a specific group of recipients and send them a message. The message may include information about the event, updates on the schedule, or other relevant details. This feature may facilitate efficient and targeted communication between the user and the recipients, enhancing the user experience and improving the efficiency of the event management process.

In some embodiments, the system may provide advanced messaging capabilities that are tailored to the specific needs and roles of the participants in an equestrian event. For instance, the system may include a messaging interface that creates dynamic groups based on roles, such as riders, trainers, event organizers, judges, staff members or additional roles. This feature may allow the event organizer to send targeted messages to specific groups of participants. For example, the event organizer may send a message to all riders informing them of a change in the event schedule, or send a message to all judges providing instructions for scoring an event. This feature may facilitate efficient and targeted communication, enhancing the user experience and improving the efficiency of the event management process.

### 5. Computer System

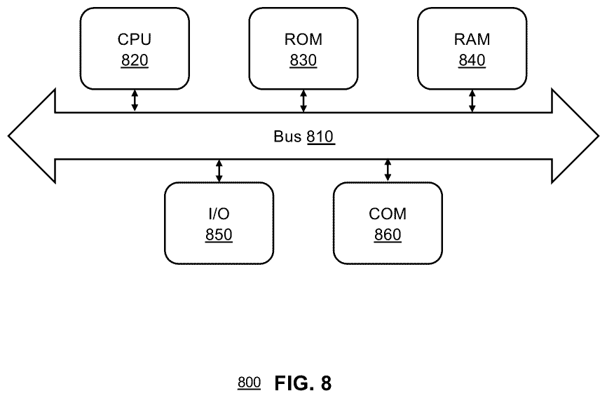

FIG. 8 depicts an example system that may execute techniques presented herein. FIG. 8 is a simplified functional block diagram of a computer that may be configured to execute techniques described herein, according to exemplary cases of the present disclosure. Specifically, the computer (or “platform” as it may not be a single physical computer infrastructure) may include a data communication interface 860 for packet data communication. The platform may also include a central processing unit (“CPU”) 820, in the form of one or more processors, for executing program instructions. The platform may include an internal communication bus 810, and the platform may also include a program storage and/or a data storage for various data files to be processed and/or communicated by the platform such as ROM 830 and RAM 840, although the system 800 may receive programming and data via network communications. The system 800 also may include input and output ports 850 to connect with input and output devices such as keyboards, mice, touchscreens, monitors, displays, etc. Of course, the various system functions may be implemented in a distributed fashion on a number of similar platforms, to distribute the processing load. Alternatively, the systems may be implemented by appropriate programming of one computer hardware platform.

The general discussion of this disclosure provides a brief, general description of a suitable computing environment in which the present disclosure may be implemented. In some cases, any of the disclosed systems, methods, and/or graphical user interfaces may be executed by or implemented by a computing system consistent with or similar to that depicted and/or explained in this disclosure. Although not required, aspects of the present disclosure are described in the context of computer-executable instructions, such as routines executed by a data processing device, e.g., a server computer, wireless device, and/or personal computer. Those skilled in the relevant art will appreciate that aspects of the present disclosure can be practiced with other communications, data processing, or computer system configurations, including: Internet appliances, hand-held devices (including personal digital assistants (“PDAs”)), wearable computers, all manner of cellular or mobile phones (including Voice over IP (“VoIP”) phones), dumb terminals, media players, gaming devices, wearables (e.g, smart watches), virtual reality devices, multi-processor systems, microprocessor-based or programmable consumer electronics, set-top boxes, network PCs, mini-computers, mainframe computers, and the like. Indeed, the terms “computer,” “server,” and the like, are generally used interchangeably herein, and refer to any of the above devices and systems, as well as any data processor.

Aspects of the present disclosure may be embodied in a special purpose computer and/or data processor that is specifically programmed, configured, and/or constructed to perform one or more of the computer-executable instructions explained in detail herein. While aspects of the present disclosure, such as certain functions, are described as being performed exclusively on a single device, the present disclosure may also be practiced in distributed environments where functions or modules are shared among disparate processing devices, which are linked through a communications network, such as a Local Area Network (“LAN”), Wide Area Network (“WAN”), and/or the Internet. Similarly, techniques presented herein as involving multiple devices may be implemented in a single device. In a distributed computing environment, program modules may be located in both local and/or remote memory storage devices.

Aspects of the present disclosure may be stored and/or distributed on non-transitory computer-readable media, including magnetically or optically readable computer discs, hard-wired or preprogrammed chips (e.g., EEPROM semiconductor chips), nanotechnology memory, biological memory, or other data storage media. Alternatively, computer implemented instructions, data structures, screen displays, and other data under aspects of the present disclosure may be distributed over the Internet and/or over other networks (including wireless networks), on a propagated signal on a propagation medium (e.g., an electromagnetic wave(s), a sound wave, etc.) over a period of time, and/or they may be provided on any analog or digital network (packet switched, circuit switched, or other scheme).

Program aspects of the technology may be thought of as “products” or “articles of manufacture” typically in the form of executable code and/or associated data that is carried on or embodied in a type of machine-readable medium. “Storage” type media include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer of the mobile communication network into the computer platform of a server and/or from a server to the mobile device. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links, or the like, also may be considered as media bearing the software. As used herein, unless restricted to non-transitory, tangible “storage” media, terms such as computer or machine “readable medium” refer to any medium that participates in providing instructions to a processor for execution.

### 6. Terminology

The terminology used above may be interpreted in its broadest reasonable manner, even though it is being used in conjunction with a detailed description of certain specific examples of the present disclosure. Indeed, certain terms may even be emphasized above; however, any terminology intended to be interpreted in any restricted manner will be overtly and specifically defined as such in this Detailed Description section. Both the foregoing general description and the detailed description are exemplary and explanatory only and are not restrictive of the features, as claimed.

As used herein, the terms “comprises,” “comprising,” “having,” including,” or other variations thereof, are intended to cover a non-exclusive inclusion such that a process, method, article, or apparatus that comprises a list of elements does not include only those elements, but may include other elements not expressly listed or inherent to such a process, method, article, or apparatus.

In this disclosure, relative terms, such as, for example, “about,” “substantially,” “generally,” and “approximately” are used to indicate a possible variation of ±10% in a stated value.

As used herein, the terms “transmit,” “provide,” “receive,” and “obtain” may refer to the transfer or communication of data, information, or signals between various components or entities. This may include, but is not limited to, transmission over a network (such as a local area network, wide area network, or the Internet), transfer between devices (such as between computers, smartphones, or other electronic devices), communication between central processing units (CPUs) or graphics processing units (GPUs), exchange of information between microservices, transfer of data between software components within an environment, or any other form of data transfer or communication as indicated by the context in which the terms are used. The specific mode or medium of transmission or provision may vary depending on the particular implementation and system architecture.

As used herein, the term “module” may refer to software code, a software component, a software function, a software application, and firmware. As indicated by context, “module” may be logical, digital, analog, optical, electronic, or quantum implementations of operations or functions. A module may be implemented as a standalone unit or as part of a larger system. In some cases, a module may interact with other modules or components to perform specific tasks or operations within the system. As indicated by context or based on design preference, any two modules may be combined. As indicated by context or based on design preference, any module may be broken into two or more modules that provide some or all of the operations or functions of the single module. The specific implementation of module(s) may vary depending on the requirements of the system and the particular application.

The term “exemplary” is used in the sense of “example” rather than “ideal.” As used herein, the singular forms “a,” “an,” and “the” include plural reference unless the context dictates otherwise.

### 7. Examples

Exemplary embodiments of the systems and methods disclosed herein are described in the numbered paragraphs below.

A1. A system comprising: at least one memory configured to store instructions; and at least one processor executing the instructions to perform operations, the operations comprising: obtain, via participant user interfaces, participant data from a plurality of user devices, wherein the participant data includes data regarding a plurality of riders, a plurality of horses with each being associated with a first one or more riders, and a plurality of trainers with each being associated with a second one or more riders; obtain, via event configuration interfaces, event configuration data, wherein the event configuration data includes data regarding a plurality of events, a plurality of locations, and a time-location mapping of events to locations at specific blocks of time; obtain, via registration user interfaces, event-participant data, wherein the event-participant data includes data regarding a selection of events, the rider for the events, the horse for the events, and the trainer for the events; in response to a request to view an event ordering user interface for a first event, generate the event ordering user interface, wherein the event ordering user interface is configured to: populate participants registered for the first event; automatically order populated participants in an order; automatically detect conflicts with a remainder of the events; re-order participants in the order; and publish the order for the first event; in response to the order being published, push notify the participants of their place in the order by push notification; in response to a change trigger condition, notify the user; in response to a request to view a global event ordering user interface based on the change trigger condition, generate the global event ordering user interface, wherein the global event ordering user interface is configured to: retrieve orders for all events, wherein the orders, respectively, include ordered lists of participants at specific time slots and a location for a respective event; populate segments of the global event ordering user interface with the orders for all the events; automatically include conflict indicators for the participants that have one or more conflicts; re-order participants in the orders; and republish the orders; in response to the orders being republished, determine affected participants; and push notify the affected participants of their place(s) in the order(s) that have changed by push notification.

A2. The system of A1, wherein the event ordering user interface is further configured to: receive user input to drag and drop participants to reorder the participants; and automatically update the order based on the drag and drop input.

A3. The system of A2, wherein the event ordering user interface is further configured to: display a visual indicator of potential conflicts after or as a participant is being dragged, and/or prevent dropping a participant into a conflicting time slot.

A4. The system of any of A2-A4, wherein the global event ordering user interface is further configured to: display a grid view showing all events across different facilities and time slots; and use types of indicators to represent different types of conflicts.

A5. The system of A4, wherein the types of indicators comprise: a first type of indicator for hard conflicts indicating overlapping events for the same participant and/or events that violate required break times; and a second type of indicator for allowable soft conflicts of break times that have been approved by a rider or trainer.

A6. The system of any of A2-A5, wherein the instructions, when executed by the at least one processor, further cause the system to: provide a messaging interface that enables grouping of recipients based on their role in the event; and send targeted messages to specific groups of participants.

A7. The system of A6, wherein the messaging interface is configured to: create dynamic groups based on roles including riders, trainers, event managers, judges, and staff; and allow filtering of recipients based on multiple criteria including event type, facility, and class.

A8. The system of any of A2-A7, wherein the operations further comprise: store the event configuration data in a hierarchical data structure, wherein the hierarchical data structure comprises: a top level representing the plurality of events; a second level representing the plurality of locations for each event; a third level representing time slots for each location; and a fourth level representing participant slots for each time slot.

A9. The system of A8, wherein the hierarchical data structure further comprises: a fifth level representing individual participants assigned to each participant slot, wherein the individual participants include riders, horses, and/or trainers.

A10. The system of A8, wherein the operations further comprise: traverse the hierarchical data structure to detect conflicts between participant assignments across different events, locations, and time slots.

A11. The system of A8, wherein the operations further comprise: update the hierarchical data structure in real-time as changes are made to event schedules or participant assignments.

A12. The system of A8, wherein the hierarchical data structure is stored in the database, and wherein the operations further comprise: query the hierarchical data structure to generate views for the event ordering user interface and the global event ordering user interface.

A13. The system of A8, wherein the operations further comprise: use the hierarchical data structure to track dependencies between events, such that changes to one event may trigger updates to related events in the hierarchy.

A14. The system of A8, wherein the operations further comprise: generate notifications based on changes detected at any level of the hierarchical data structure.

A15. The system of any of A2-A14, wherein the operations further comprise: detect conflicts for participants by comparing time slots and locations of events for which each participant is registered; generate conflict indicators for detected conflicts; and display the conflict indicators in the global event ordering user interface.

A16. The system of A15, wherein detecting conflicts for participants comprises: identifying overlapping time slots for events assigned to the same participant; determining if sufficient travel time exists between consecutive events for a participant at different locations; and flagging events that violate predefined break time requirements for participants.

A17. The system of A15, wherein the operations further comprise: assign a severity level to each detected conflict based on predefined criteria; and visually differentiate conflict indicators in the global event ordering user interface based on the assigned severity levels.

A18. The system of A15, wherein the operations further comprise: automatically suggest alternative time slots or event assignments to resolve detected conflicts; display the suggested alternatives in the global event ordering user interface; and enable user selection of suggested alternatives to update event assignments.

A19. The system of A15, wherein the operations further comprise: monitor real-time updates to event schedules and participant assignments; dynamically recalculate conflicts based on the real-time updates; and update conflict indicators in the global event ordering user interface in response to recalculated conflicts.

A20. The system of A15, wherein detecting conflicts for participants comprises: applying participant-specific rules for conflict detection, wherein the participant-specific rules may include customized break time requirements, travel time allowances, or event priority settings for individual participants or groups of participants.

A21. The system of any of A2-A20, wherein the operations further comprise: receive a user input to add a break slot with a customizable duration to the order; automatically adjust time slots for participants following the added break slot; and update the order based on the adjusted time slots.

A22. The system of A21, wherein automatically adjusting time slots comprises: determining a start time for the break slot; adding the customizable duration to the start time to determine an end time for the break slot; and shifting time slots for subsequent participants based on the end time of the break slot.

A23. The system of A21, wherein the operations further comprise: detect potential conflicts caused by the addition of the break slot; and display visual indicators of the detected potential conflicts in the event ordering user interface.

A24. The system of A21, wherein the operations further comprise: receive user input to drag and drop the added break slot to a different position in the order; dynamically recalculate time slots for participants based on the new position of the break slot; and update the order in real-time to reflect the recalculated time slots.

A25. The system of A21, wherein the operations further comprise: generate notifications for participants affected by the addition of the break slot; and push notify the affected participants of their updated time slots.

A26. The system of any of A2-A25, wherein the operations further comprise: receive a request to modify the order for the first event after the event has started; display a warning message indicating that changes are being made to an ongoing event; in response to receiving confirmation to proceed with the modification: update the order for the first event; identify participants affected by the modification; and send an urgent notification to the affected participants.

A27. The system of A26, wherein the operations further comprise: determine a current progress status of the first event; adjust subsequent time slots in the order based on the current progress status and the modification; and update the event ordering user interface to reflect the adjusted time slots.

A28. The system of any of A2-A27, wherein the operations further comprise: detect a request to modify the order for the first event within a predetermined threshold period before the scheduled start time of the first event; in response to detecting the request within the threshold period: display a warning message indicating proximity to the event start time; implement the modification to the order; generate a priority notification for all participants in the first event; and push notify the participants of the modified order using the priority notification.

A29. The system of any of A2-A28, wherein the operations further comprise: monitor real-time progress of the first event; detect a deviation from the published order during the first event; automatically adjust subsequent time slots in the order based on the detected deviation; and push notify affected participants of the adjusted time slots.

A30. The system of any of A2-A29, wherein the push notification is configured based on a role of each participant, and wherein the operations further comprise: determine a role of each affected participant; customize the content of the push notification based on the determined role; and send the customized push notification to each affected participant.

A31. The system of A30, wherein the role of each participant may include rider, trainer, event organizer, judge, or staff member.

A32. The system of A30, wherein customizing the content of the push notification comprises: include role-specific information in the push notification; and adjust the level of detail in the push notification based on the determined role.

A33. The system of A30, wherein the operations further comprise: set a priority level for the push notification based on the determined role; and deliver the push notification according to the set priority level.

A34. The system of A30, wherein the operations further comprise: group affected participants based on their roles; and send batch notifications to each group of participants with similar roles.

A35. The system of any of A2-A34, wherein the change trigger condition comprises a participant cancelling an event.

A36. The system of any of A2-A35, wherein the change trigger condition comprises a participant being moved in an order and causing a conflict with their own events or events of other participants.

A37. The system of A36, wherein the operations further comprise: detect the conflict caused by the participant being moved in the order; identify affected participants; and generate notifications for the affected participants indicating the detected conflict.

A38. The system of A35, wherein the operations further comprise: update the order to remove the participant that cancelled event; adjust time slots for subsequent participants; and generate notifications for participants affected by the adjusted time slots.

A39. The system of A36, wherein the operations further comprise: analyze the conflict caused by the participant being moved; suggest alternative time slots or event assignments to resolve the conflict; and display the suggested alternatives in the event ordering user interface.

A40. The system of any of A2-A39, wherein the participant data further includes data regarding owners, coaches, and/or grooms associated with one or more riders or one or more horses.

A41. A computer-implemented method comprising: obtaining participant data from a plurality of user devices; obtaining event configuration data; obtaining event-participant data; generating a published order using an event ordering user interface for a first event based on the participant data, the event configuration data, and the event-participant data; push notifying participants of their place in the published order;

A42. A non-transitory computer-readable medium storing instructions that, when executed by at least one processor, cause the at least one processor to perform operations comprising: generating a global event ordering user interface; retrieving orders for events; populating the global event ordering user interface with the orders including indicators for timeslot conflicts in the global event ordering user interface; modifying the orders; publishing the modified orders; and notifying participants of changes in the republished orders.

Other aspects of the disclosure will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A system comprising:
at least one memory configured to store instructions; and
at least one processor executing the instructions to perform operations, the operations comprising:
obtain, via participant user interfaces, participant data from a plurality of user devices, wherein the participant data includes data regarding a plurality of riders, a plurality of horses, a plurality of trainers, a plurality of owners, a plurality of coaches, a plurality of guardians, and a plurality of grooms, with each being with associated a first one or more riders;
obtain, via event configuration interfaces, event configuration data, wherein the event configuration data includes data regarding a plurality of events, a plurality of locations, and a time-location mapping of events to locations at specific blocks of time;
obtain, via registration user interfaces, event-participant data, wherein the event-participant data includes data regarding a selection of events, the rider for the events, the horse for the events, the trainer for the events, the coach for the events, and the owners for the events;
in response to a request to view an event ordering user interface for a first event, generate the event ordering user interface,
wherein the event ordering user interface is configured to:
populate participants registered for the first event;
order, via user interactions, populated participants in an order;
automatically detect conflicts with a remainder of the events;
re-order participants in the order; and
publish the order for the first event;
in response to the order being published, push notify the participants of their place in the order by push notification;
in response to a change trigger condition, notify the user;
in response to a request to view a global event ordering user interface based on the change trigger condition, generate the global event ordering user interface,
wherein the global event ordering user interface is configured to:
retrieve orders for all events, wherein the orders, respectively, include ordered lists of participants at specific time slots and a location for a respective event;
populate segments of the global event ordering user interface with the orders for all the events;
automatically include conflict indicators for the participants that have one or more conflicts;
re-order participants in the orders; and
republish the orders;
in response to the orders being republished, determine affected participants; and
push notify the affected participants of their place(s) in the order(s) that have changed by push notification.

2. The system of claim 1, wherein the event ordering user interface is further configured to: receive user input to drag and drop participants to reorder the participants; and automatically update the order based on the drag and drop input.

3. The system of claim 2, wherein the event ordering user interface is further configured to: display a visual indicator of potential conflicts after or as a participant is being dragged, and/or prevent dropping a participant into a conflicting time slot.

4. The system of claim 1, wherein the global event ordering user interface is further configured to: display a grid view showing all events across different facilities and time slots; and use types of indicators to represent different types of conflicts.

5. The system of claim 4, wherein the types of indicators comprise: a first type of indicator for hard conflicts indicating overlapping events for the same participant and/or events that violate required break times; and a second type of indicator for allowable soft conflicts of break times that have been approved by a rider, coach, or trainer.

6. The system of claim 1, wherein the instructions, when executed by the at least one processor, further cause the system to: provide a messaging interface that enables grouping of recipients based on their role in the event; and send targeted messages to specific groups of participants.

7. The system of claim 6, wherein the messaging interface is configured to: create dynamic groups based on roles including riders, trainers, coaches, owners, event managers, judges, and staff; and allow filtering of recipients based on multiple criteria including event type, facility, and class.

8. The system of claim 1, wherein the operations further comprise: store the event configuration data in a hierarchical data structure, wherein the hierarchical data structure comprises: a top level representing the plurality of events; a second level representing the plurality of locations for each event; a third level representing time slots for each location; and a fourth level representing participant slots for each time slot.

9. The system of claim 8, wherein the hierarchical data structure further comprises: a fifth level representing individual participants assigned to each participant slot, wherein the individual participants include riders, horses, coaches, owners, and/or trainers.

10. The system of claim 8, wherein the operations further comprise: traverse the hierarchical data structure to detect conflicts between participant assignments across different events, locations, and time slots.

11. The system of claim 8, wherein the operations further comprise: update the hierarchical data structure in real-time as changes are made to event schedules or participant assignments.

12. The system of claim 8, wherein the hierarchical data structure is stored in the database, and wherein the operations further comprise: query the hierarchical data structure to generate views for the event ordering user interface and the global event ordering user interface.

13. The system of claim 8, wherein the operations further comprise: use the hierarchical data structure to track dependencies between events, such that changes to one event may trigger updates to related events in the hierarchy.

14. The system of claim 1, wherein the operations further comprise: detect conflicts for participants by comparing time slots and locations of events for which each participant is registered; generate conflict indicators for detected conflicts; and display the conflict indicators in the global event ordering user interface.

15. The system of claim 14, wherein detecting conflicts for participants comprises: identifying overlapping time slots for events assigned to the same participant; determining if sufficient travel time exists between consecutive events for a participant at different locations; and flagging events that violate predefined break time requirements for participants.

16. The system of claim 14, wherein the operations further comprise: automatically suggest alternative time slots or event assignments to resolve detected conflicts; display the suggested alternatives in the global event ordering user interface; and enable user selection of suggested alternatives to update event assignments.

17. The system of claim 1, wherein the operations further comprise: receive a user input to add a break slot with a customizable duration to the order; automatically adjust time slots for participants following the added break slot; and update the order based on the adjusted time slots.

18. The system of claim 17, wherein automatically adjusting time slots comprises: determining a start time for the break slot; adding the customizable duration to the start time to determine an end time for the break slot; and shifting time slots for subsequent participants based on the end time of the break slot.

19. The system of claim 17, wherein the operations further comprise: detect potential conflicts caused by the addition of the break slot; and display visual indicators of the detected potential conflicts in the event ordering user interface.

20. The system of claim 17, wherein the operations further comprise: receive user input to drag and drop the added break slot to a different position in the order; dynamically recalculate time slots for participants based on the new position of the break slot; and update the order in real-time to reflect the recalculated time slots.

21. The system of claim 17, wherein the operations further comprise: generate notifications for participants affected by the addition of the break slot; and push notify the affected participants of their updated time slots.

22. The system of claim 1, wherein the operations further comprise: receive a request to modify the order for the first event after the event has started; display a warning message indicating that changes are being made to an ongoing event; in response to receiving confirmation to proceed with the modification: update the order for the first event; identify participants affected by the modification; and send an urgent notification to the affected participants.

23. The system of claim 1, wherein the operations further comprise: detect a request to modify the order for the first event within a predetermined threshold period before the scheduled start time of the first event; in response to detecting the request within the threshold period: display a warning message indicating proximity to the event start time; implement the modification to the order; generate a priority notification for all participants in the first event; and push notify the participants of the modified order using the priority notification.

24. The system of claim 1, wherein the push notification is configured based on a role of each participant, and wherein the operations further comprise: determine a role of each affected participant; customize the content of the push notification based on the determined role; and send the customized push notification to each affected participant.

25. The system of claim 1, wherein the change trigger condition comprises a participant cancelling an event.

26. The system of claim 25, wherein the operations further comprise: update the order to remove the participant that cancelled event; adjust time slots for subsequent participants; and generate notifications for participants affected by the adjusted time slots.

27. The system of claim 1, wherein the change trigger condition comprises a participant being moved in an order and causing a conflict with their own events or events of other participants.

28. The system of claim 27, wherein the operations further comprise: detect the conflict caused by the participant being moved in the order; identify affected participants; and generate notifications for the affected participants indicating the detected conflict.

29. A computer-implemented method comprising:
obtaining participant data from a plurality of user devices;
obtaining event configuration data;
obtaining event-participant data;
generating a published order using an event ordering user interface for a first event based on the participant data, the event configuration data, and the event-participant data; and
push notifying participants of their place in the published order.

30. A non-transitory computer-readable medium storing instructions that, when executed by at least one processor, cause the at least one processor to perform operations comprising:
generating a global event ordering user interface;
retrieving orders for events;
populating the global event ordering user interface with the orders including indicators for timeslot conflicts in the global event ordering user interface;
modifying the orders;
publishing the modified orders; and
notifying participants of changes in the republished orders.
